(19) United States
(12) Patent Application Publication
(10) Pub. No.: US 2026/0180272 A1
(43) Pub. Date: Jun. 25, 2026

(54) ELECTRICAL CONNECTION UNIT

(71) Applicant: YAZAKI CORPORATION, Tokyo (JP)

(72) Inventors: Kazutaka Uki, Kakegawa-shi (JP); Yuuki Miyazawa, Kakegawa-shi (JP); Mitsuru Saito, Kakegawa-shi (JP); Tatsuya Shiraishi, Kakegawa-shi (JP)

(21) Appl. No.: 19/430,266

(22) Filed: Dec. 23, 2025

(30) Foreign Application Priority Data
Dec. 25, 2024 (JP) 2024-228958

(51) Int. Cl. H01R 25/16; H01R 4/02; H01R 4/06; H01R 4/34

(52) U.S. Cl. CPC H01R 25/162; H01R 4/029; H01R 4/06; H01R 4/34

(57) ABSTRACT

An electrical connection unit includes an electronic component, a wiring member, a first metal member, and a second metal member. The electronic component has a terminal. The first metal member includes a first portion fixed to the terminal by a first fastening member and a second portion fixed to the wiring member. The second metal member includes a recess into which the second portion of the first metal member is fitted, and is attached to the second portion of the first metal member.

### BACKGROUND OF THE INVENTION

### Field of the Invention

Embodiments of the present invention relate to an electrical connection unit.

Priority is claimed on Japanese Patent Application No. 2024-228958 filed in Japan on December 25, 2024, the content of which is incorporated herein by reference.

### Description of Related Art

An electrical connection unit including an electronic component and a wiring member electrically connected to the electronic component is known.

### Prior Art Document

### Patent Document

### Patent Document 1: Japanese Unexamined Patent Application, First Publication No. 2024-037492

### SUMMARY OF THE INVENTION

Improvement in the thermal characteristics of the electrical connection unit is expected.

An embodiment provides an electrical connection unit capable of improving thermal characteristics.

An electrical connection unit according to an embodiment includes an electronic component, a wiring member, a first metal member, and a second metal member. The electronic component has a terminal. The first metal member includes a first portion fixed to the terminal by a first fastening member and a second portion fixed to the wiring member. The second metal member includes a recess into which the second portion of the first metal member is fitted, and is attached to the second portion of the first metal member.

According to an embodiment, thermal characteristics can be improved.

### BRIEF DESCRIPTION OF THE DRAWINGS

FIG. 1 is a partially exploded perspective view of an electrical connection unit according to an embodiment.

FIG. 2 is a perspective view for describing electronic components and connection components according to the embodiment.

FIG. 3 is a perspective view for describing bus bars according to the embodiment.

FIG. 4 is a perspective view for describing connection components according to a first aspect of the embodiment.

FIG. 5 is a cross-sectional view illustrating a part of an electrical connection unit according to the first aspect of the embodiment.

FIG. 6 is a plan view illustrating a part of the electrical connection unit according to the first aspect of the embodiment.

FIG. 7 is a cross-sectional view for describing a modification of the electrical connection unit according to the first aspect of the embodiment.

FIG. 8 is a perspective view for describing Example 1 of connection components according to a second aspect of the embodiment.

FIG. 9 is a perspective view for describing Example 2 of the connection components according to the second aspect of the embodiment.

FIG. 10 is a perspective view for describing Example 3 of the connection components according to the second aspect of the embodiment.

FIG. 11 is a perspective view for describing Example 4 of the connection components according to the second aspect of the embodiment.

FIG. 12 is a perspective view for describing Example 5 of the connection components according to the second aspect of the embodiment.

FIG. 13 is a perspective view for describing Example 6 of the connection components according to the second aspect of the embodiment.

FIG. 14 is a perspective view for describing Example 7 of the connection components according to the second aspect of the embodiment.

FIG. 15 is a perspective view for describing Example 8 of the connection components according to the second aspect of the embodiment.

FIG. 16 is a perspective view for describing Example 1 of connection components according to a third aspect of the embodiment.

FIG. 17 is a partially exploded perspective view of an electrical connection unit according to the third aspect of the embodiment.

FIG. 18 is a plan view for describing Example 1 of the connection components according to the third aspect of the embodiment.

FIG. 19 is a cross-sectional view for describing Example 1 of the connection components according to the third aspect of the embodiment.

FIG. 20 is a perspective view for describing Example 2 of the connection components according to the third aspect of the embodiment.

FIG. 21 is a cross-sectional view for describing Example 2 of the connection components according to the third aspect of the embodiment.

FIG. 22 is a perspective view for describing Example 3 of the connection components according to the third aspect of the embodiment.

FIG. 23 is a cross-sectional view for describing Example 3 of the connection components according to the third aspect of the embodiment.

FIG. 24 is a perspective view for describing Example 4 of the connection components according to the third aspect of the embodiment.

FIG. 25 is a cross-sectional view for describing Example 4 of the connection components according to the third aspect of the embodiment.

### DETAILED DESCRIPTION OF THE INVENTION

Hereinafter, embodiments will be described with reference to the drawings. In the following description, constitutions having the same or similar functions are denoted by the same reference numbers. Redundant descriptions of these constitutions may be omitted. The constitution to be described below does not limit the scope of the embodiment.

In the present disclosure, the terms are defined as follows. The term “connection” is not limited to a mechanical connection, and may include an electrical connection. That is, the term “connection” is not limited to a case where two elements that are connection targets are directly connected, and may include a case where two elements that are connection targets are connected with another element interposed therebetween. The term “facing”, “overlapping”, or “adjacent” means that virtual projection images of two target objects overlap each other when viewed from a specific direction. That is, the term “facing” or “overlapping” is not limited to a case where two target objects directly face each other, and may include a case where two target objects face each other in a state in which another member or a gap exists between the two target objects. In addition, the term “facing” or “overlapping” is not limited to a case of completely overlapping when viewed from the specific direction, and may include a case of at least partially overlapping. The term “adjacent” is not limited to a case where two target objects are adjacent to each other, and may include a case where two target objects are arranged in a state where another member or a gap exists between the two objects. The term “parallel”, “orthogonal”, or “the same” may include “substantially parallel”, “substantially orthogonal”, or “substantially the same”, respectively.

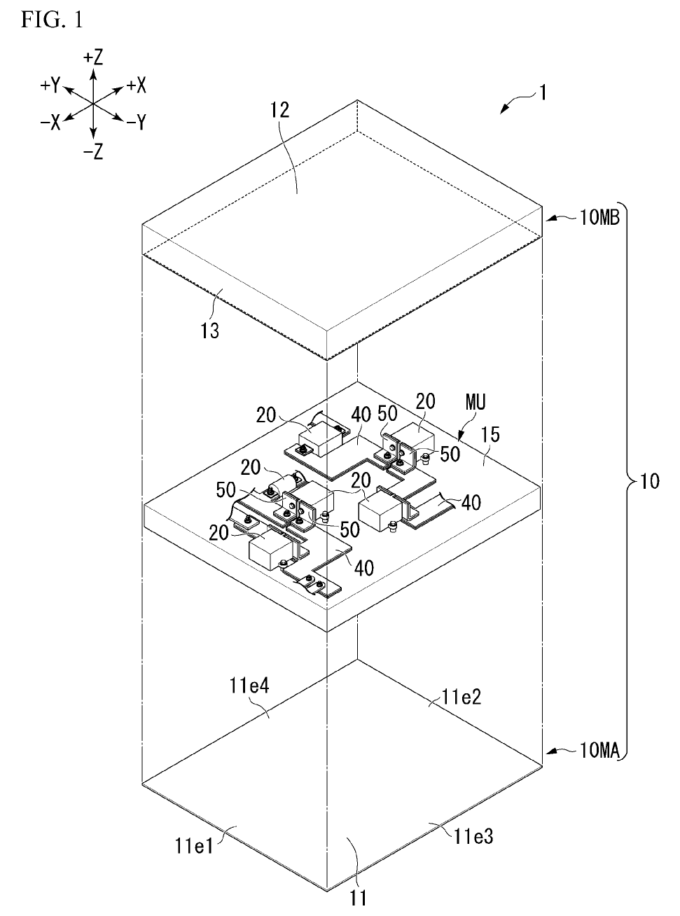

In the present disclosure, a +X direction, a -X direction, a +Y direction, a -Y direction, a +Z direction, and a -Z direction are defined as follows. The +X direction is a direction from a first end 11e1 to a second end 11e2 of a lower wall 11 of a housing 10 that will be described later (see FIG. 1). The -X direction is a direction opposite to the +X direction. Hereinafter, in a case where the +X direction and the -X direction are not distinguished, the directions will be simply referred to as “X direction”. The +Y direction and the -Y direction are directions intersecting (for example, orthogonal to) the X direction. The +Y direction is a direction from a third end 11e3 to a fourth end 11e4 of the lower wall 11 of the housing 10 that will be described later (see FIG. 1). The -Y direction is a direction opposite to the +Y direction. Hereinafter, in a case where the +Y direction and the -Y direction are not distinguished, the directions will be simply referred to as “Y direction”. The +Z direction and the -Z direction are directions intersecting (for example, orthogonal to) the X direction and the Y direction. The +Z direction is a direction from the lower wall 11 of the housing 10 that will be described later toward a main body MU (see FIG. 1). The -Z direction is a direction opposite to the +Z direction. Hereinafter, in a case where the +Z direction and the -Z direction are not distinguished, the directions will be simply referred to as “Z direction”.

Hereinafter, in a case where the X direction and the Y direction are not distinguished, the directions may be referred to as “horizontal direction”. Hereinafter, the Z direction may be referred to as “vertical direction”. Hereinafter, the +Z direction side may be referred to as “upper”, and the -Z direction side may be referred to as “lower”. However, these expressions are expressions for convenience of description, and do not limit a gravity direction of an electrical connection unit 1 (an installation posture of the electrical connection unit 1).

### EMBODIMENT

### 1. Configuration of Electrical Connection Unit

FIG. 1 is a partially exploded perspective view of an electrical connection unit 1 according to an embodiment. The electrical connection unit 1 is, for example, an in-vehicle device mounted on a vehicle such as an electric vehicle (EV), a hybrid electric vehicle (HEV), or a plug-in hybrid electric vehicle (PHEV). The electrical connection unit 1 may be referred to as an “electrical connection box” or a “junction box”, for example. However, the electrical connection unit 1 is not limited to a box-shaped device. The electrical connection unit 1 includes, for example, the housing 10 and the main body MU.

### Housing

The housing 10 is a member forming the outer casing of the electrical connection unit 1. The housing 10 has, for example, a flat box shape. The housing 10 is made of, for example, a synthetic resin and has an insulating property. The housing 10 accommodates the main body MU. The housing 10 has, for example, a lower wall 11 (first wall portion), an upper wall 12 (second wall portion), and a peripheral wall 13 (third wall portion). The lower wall 11 covers at least a part of the main body MU from below (-Z direction side). The upper wall 12 covers at least a part of the main body MU from above (+Z direction side). The peripheral wall 13 surrounds the periphery of the main body MU.

The housing 10 includes, for example, a first member 10MA including the lower wall 11 and a second member 10MB including the upper wall 12 and the peripheral wall 13. In the present embodiment, the housing 10 is formed by combining the first member 10MA and the second member 10MB. Note that the lower wall 11 may be formed of an insulating sheet or the like, instead of a wall having rigidity. A part or all of the housing 10 may be omitted.

### Main Body

The main body MU is a portion that performs main functions (for example, switching of electrical connection states or overcurrent protection) of the electrical connection unit 1. The main body MU may be referred to as a “circuit constituent body”. The main body MU includes, for example, a base member 15, a plurality of electronic components 20, a plurality of bus bars 40, and a plurality of connection components 50.

### 2. Base Member

First, the base member 15 will be described. The base member 15 is a member that supports one or more electronic components 20 and/or one or more bus bars 40 inside the housing 10. The base member 15 is made of, for example, a synthetic resin and has an insulating property. The base member 15 is disposed between the electronic components 20 and the bus bars 40, and the lower wall 11 of the housing 10 in the Z direction. The base member 15 is fixed to the lower wall 11 of the housing 10, for example. The base member 15 supports the one or more electronic components 20 and/or the one or more bus bars 40 from below. The base member 15 may be a wall portion along the horizontal direction, a structure in which a plurality of ribs standing in the vertical direction are combined, or the like. The base member 15 may be formed by a part of the housing 10.

### 3. Electronic Component

Next, an electronic component 20 will be described. The electronic component 20 is an electronic component mounted in accordance with a function required for the main body MU. The electronic component 20 is, for example, a connector, a fuse, a relay (for example, a mechanical relay or a semiconductor relay), a capacitor, a branch component, any of various sensors (for example, a current sensor or a voltage sensor), an electronic control unit, or an electronic component unit in which two or more of these are unitized. However, the type of the electronic component 20 is not limited to the above example. The electronic component 20 is, for example, a heat generating component that generates heat at the time of energization.

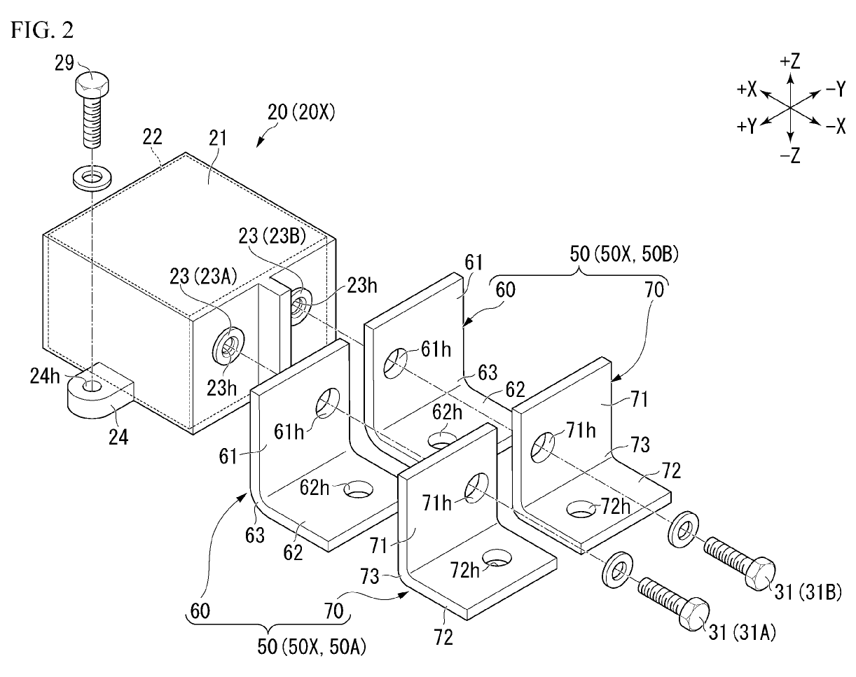

FIG. 2 is a perspective view for describing an electronic component 20 and a connection component 50. FIG. 2 illustrates an electronic component 20X as an example of the electronic component 20. The electronic component 20X includes, for example, a case 21, a component body portion 22, a plurality of terminals 23, and a plurality of attachment portions 24 (only one is illustrated in FIG. 2).

### Case

The case 21 is an outer member that forms most of the outer shape of the electronic component 20. The case 21 is made of, for example, a synthetic resin and has an insulating property. The case 21 accommodates the component body portion 22. Note that the case 21 and the component body portion 22 may be integrally formed.

### Component Body Portion

The component body portion 22 is a portion that performs a main function of the electronic component 20. For example, in a case where the electronic component 20 is a relay, the component body portion 22 includes a switch (for example, a contact) that switches between a conductive state and a non-conductive state. For example, in a case where the electronic component 20 is a fuse, the component body portion 22 includes a fusible portion that melts when an overcurrent flows. For example, in a case where the electronic component 20 is a capacitor, the component body portion 22 includes a portion that accumulates electric charges.

### Terminal

Each of the terminals 23 is an electrical connection portion exposed to the outside of the case 21. The terminal 23 is electrically connected to the component body portion 22 inside the case 21. In the present embodiment, the electronic component 20 includes a terminal 23A and a terminal 23B as the plurality of terminals 23. One of the terminal 23A and the terminal 23B is a terminal on the positive electrode side. The other of the terminal 23A and the terminal 23B is a terminal on the negative electrode side. One of the terminal 23A and the terminal 23B is an example of a “first terminal”. The other of the terminal 23A and the terminal 23B is an example of a “second terminal”.

In the example illustrated in FIG. 2, the terminal 23A and the terminal 23B are provided at one end of the electronic component 20 in the horizontal direction (for example, the X direction). The terminal 23A and the terminal 23B are disposed side by side in the horizontal direction (for example, the Y direction). The terminal 23A and the terminal 23B are oriented in the horizontal direction (for example, the X direction).

Each terminal 23 has an attachment hole 23h into which the fastening member 31 (for example, a screw or a bolt) to be described later is inserted. The attachment hole 23h is open in the horizontal direction (for example, the -X direction). In the present embodiment, the fastening member 31 is inserted into the attachment hole 23h from the X direction (for example, from the -X direction side). An inner circumferential surface of the attachment hole 23h of electronic component 20 has a screw groove. The attachment hole 23h is a bottomed engagement hole provided in the electronic component 20.

### Attachment portion

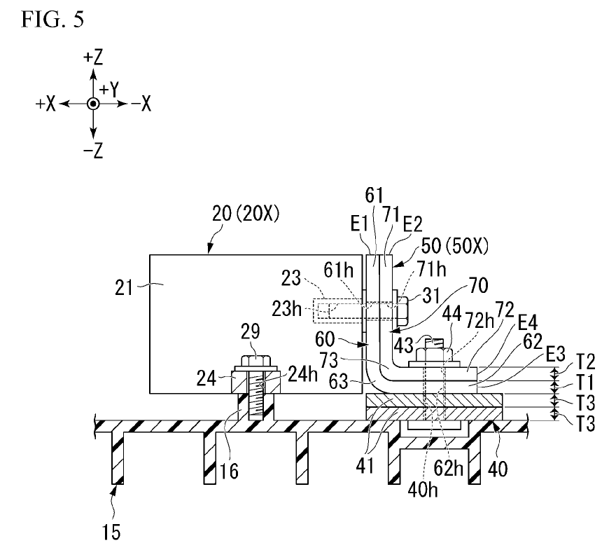

The attachment portions 24 are portions for fixing the electronic components 20. For example, the attachment portion 24 is overlapped with a fixing portion 16 (for example, a boss; see FIG. 5) provided on the base member 15 from the Z direction. The attachment portion 24 has an attachment hole 24h through which a fastening member 29 (for example, a screw or a bolt) is inserted. The attachment hole 24h is open in the Z direction. The attachment portion 24 is attached to the base member 15 by fixing the fastening member 29 that has passed through the attachment hole 24h to the fixing portion 16 of the base member 15. The electronic component 20 is fixed to the base member 15 when the attachment portion 24 is attached to the base member 15.

### 4. Bus Bar

Next, the bus bars 40 will be described.

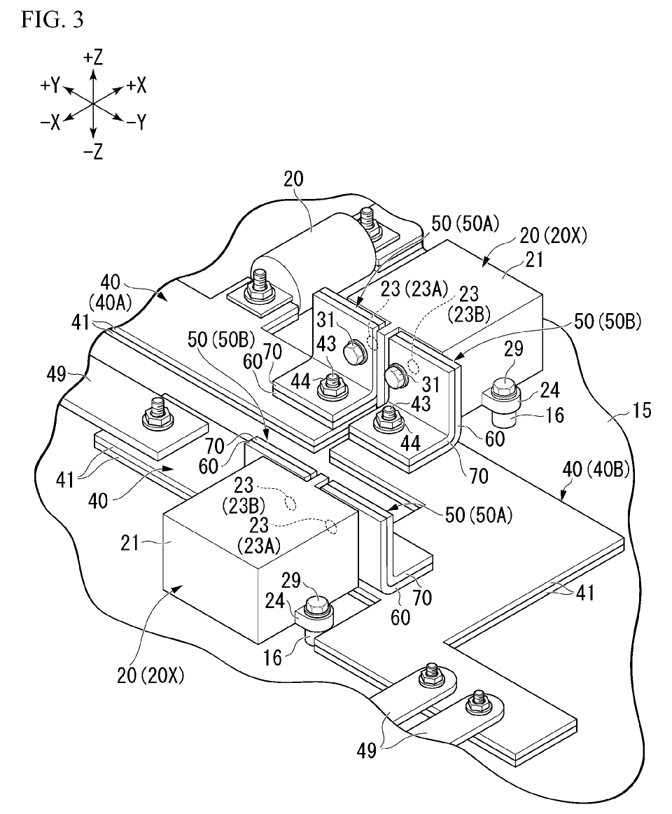

FIG. 3 is a perspective view for describing the bus bars 40. The bus bars 40 are members for forming conductive paths in the electrical connection unit 1. Each of several bus bars 40 extends between the plurality of electronic components 20 and electrically connects the plurality of electronic components 20. In addition, each of the other several bus bars 40 extends between the electronic component 20 and another connection target component (for example, a bus bar 49 for external connection), and electrically connects the electronic component 20 and the connection target component. The bus bars 40 are an example of a “wiring member”. The bus bars 40 may be referred to as a “wiring portion”. The plurality of bus bars 40 include, for example, a first bus bar 40A and a second bus bar 40B.

In the present embodiment, the bus bars 40 are formed in a plate shape extending along the horizontal direction. The bus bars 40 extend in the X direction or the Y direction. The bus bars 40 are disposed away from the terminals 23 of the electronic components 20 in the Z direction.

In the present embodiment, the bus bars 40 are formed by disposing a plurality of (for example, two) metal plates 41 in an overlapping manner in the Z direction. The metal plates 41 have a plate shape extending along the horizontal direction. A plate thickness T3 (thickness in the Z direction, see FIG. 5) of each metal plate 41 is, for example, 3 mm. The metal plate 41 is made of, for example, copper, a copper alloy, aluminum, or an aluminum alloy. Note that each bus bar 40 may be formed of one metal plate instead of a plurality of metal plates 41 formed in an overlapping manner.

### 5. Connection Component

Next, the connection components 50 will be described. The connection components 50 are components each for connecting an electronic component 20X to a bus bar 40. Each connection component 50 is disposed between an electronic component 20X and a bus bar 40, and electrically connects the electronic component 20X and the bus bar 40. Note that, in the present disclosure, “disposed between an electronic component and a bus bar” is not limited to a case of being positioned between an electronic component and a bus bar when viewed from the X direction or the Y direction, and may include a case of being positioned between an electronic component and a bus bar when viewed from a direction inclined with respect to the horizontal direction.

In the present embodiment, the electrical connection unit 1 includes, as the connection components 50, one or more of a connection component 50X of the first aspect, a connection component 50Y of the second aspect, or a connection component 50Z of the third aspect. Hereinafter, these connection components 50X, 50Y, and 50Z will be described in order.

### 6. Connection Component of First Aspect

### 6.1 Overall Configuration of Connection Component of First Aspect

First, the connection component 50X of the first aspect will be described.

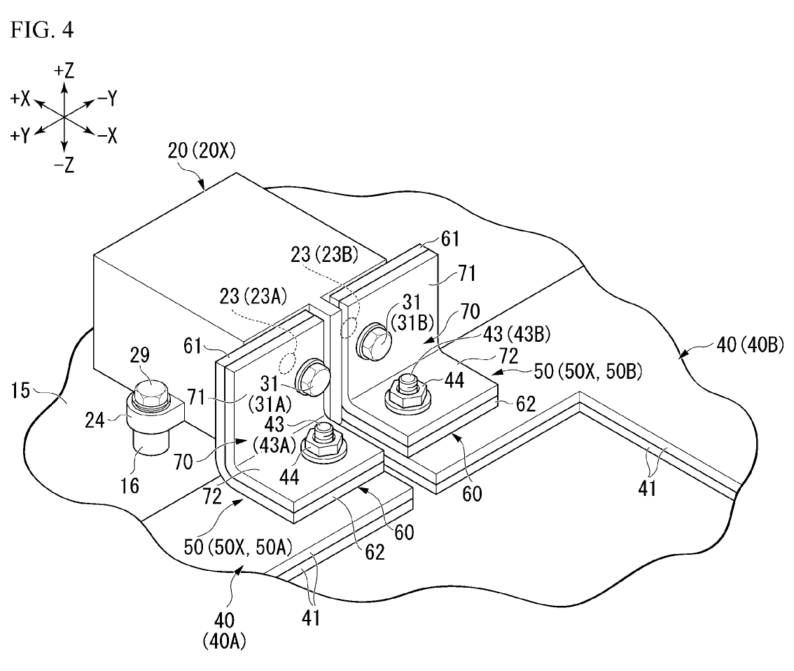

FIG. 4 is a perspective view for describing the connection component 50X of the first aspect. The connection component 50X of the first aspect includes a first metal plate 60 and a second metal plate 70. The connection component 50X is formed by disposing the first metal plate 60 and the second metal plate 70 in an overlapping manner. The first metal plate 60 is formed by, for example, bending one metal plate into an L shape by plastic working such as press working. Likewise, the second metal plate 70 is formed by, for example, bending one metal plate into an L shape by plastic working such as press working.

Each of the first metal plate 60 and the second metal plate 70 is made of, for example, copper, a copper alloy, aluminum, or an aluminum alloy. The first metal plate 60 and the second metal plate 70 are, for example, members made of the same material. When the first metal plate 60 and the second metal plate 70 have the same thickness and material, the first metal plate 60 and the second metal plate 70 can be manufactured from a common material. In this case, it is easy to reduce the manufacturing cost (for example, the material procurement cost) of the electrical connection unit 1.

Alternatively, the first metal plate 60 and the second metal plate 70 may be made of different materials. For example, one of the first metal plate 60 and the second metal plate 70 may be formed of copper or a copper alloy, and the other of the first metal plate 60 and the second metal plate 70 may be formed of aluminum or an aluminum alloy. In this case, it is easy to achieve both thermal conductivity and weight reduction.

In the present embodiment, a plate thickness T1 of the first metal plate 60 and a plate thickness T2 of the second metal plate 70 are equal (see FIG. 5). Each of the plate thickness T1 of the first metal plate 60 and the plate thickness T2 of the second metal plate 70 is, for example, 3 mm. For example, when the thickness and material of the first metal plate 60 and the second metal plate 70 are the same as the thickness and material of the metal plates 41 of the bus bars 40, the metal plates 41, the first metal plate 60, and the second metal plate 70 can be manufactured from the same material. In this case, it is easy to further reduce the manufacturing costs (for example, the material procurement costs) for the electrical connection unit 1.

### 6.2 First Metal Plate

Next, details of the first metal plate 60 will be described with reference to FIG. 2. The first metal plate 60 includes a first portion 61 and a second portion 62.

### First Portion

The first portion 61 extends in the Z direction along the end of the electronic component 20X in the X direction. The first portion 61 has a plate shape extending along the Y direction and the Z direction. The first portion 61 at least partially overlaps the electronic component 20 when viewed from the X direction. For example, the first portion 61 overlaps the terminal 23 of the electronic component 20X when viewed from the X direction.

The first portion 61 has an attachment hole 61h. The attachment hole 61h is a through hole penetrating the first portion 61 in the X direction. The attachment hole 61h faces the terminal 23 of the electronic component 20X in the X direction. The attachment hole 61h does not have, for example, screw grooves. The attachment hole 61h receives insertion of the fastening member 31. The first portion 61 is fixed to the terminal 23 of the electronic component 20X by engagement of the fastening member 31 that has passed through the attachment hole 61h with the attachment hole 23h of the terminal 23 of the electronic component 20X. In other words, the first portion 61 is fixed to the terminal 23 of the electronic component 20X by the fastening member 31. The fastening member 31 is an example of a “first fastening member”.

### Second Portion

The second portion 62 is bent in the -X direction from an end portion of the first portion 61 at the -Z direction side and extends along the X direction. The second portion 62 has a plate shape extending along the X direction and the Y direction. The second portion 62 extends along the bus bar 40 (see FIG. 4). The second portion 62 at least partially overlaps the bus bar 40 when viewed from the Z direction (see FIG. 4).

In the present embodiment, a fastening member 43 is attached to the bus bar 40. The fastening member 43 is, for example, a rivet bolt fixed to the bus bar 40. In the present embodiment, the bus bar 40 has a through hole 40h (see FIG. 5). The through hole 40h penetrates the bus bar 40 in the Z direction. The fastening member 43 passes through the through hole 40h of the bus bar 40 and protrudes from the bus bar 40 to the +Z direction side.

The second portion 62 of the first metal plate 60 has an attachment hole 62h. The attachment hole 62h is a through hole penetrating the second portion 62 in the Z direction. The attachment hole 62h does not have, for example, screw grooves. The attachment hole 62h receives insertion of the fastening member 43 (see FIG. 5). The second portion 62 is fixed to the bus bar 40 by engaging an engagement member 44 (for example, a nut) with a tip portion of the fastening member 43 that has passed through the attachment hole 62h (see FIG. 5). In other words, the second portion 62 is fixed to the bus bar 40 by the fastening member 43. The fastening member 43 is an example of a “second fastening member”.

### Arcuate Portion

At the boundary portion between the first portion 61 and the second portion 62, an arcuate portion 63 is formed by bending the second portion 62 with respect to the first portion 61. The arcuate portion 63 is formed in an arcuate shape having a first curvature radius.

### 6.3 Second Metal Plate

Next, details of the second metal plate 70 will be described with reference to FIG. 2. The second metal plate 70 includes a third portion 71 and a fourth portion 72.

### Third Portion

The third portion 71 extends in the Z direction along the first portion 61 of the first metal plate 60. The third portion 71 has a plate shape extending along the Y direction and the Z direction. The third portion 71 at least partially overlaps the electronic component 20 when viewed from the X direction. For example, the third portion 71 overlaps the terminal 23 of the electronic component 20X when viewed from the X direction. The third portion 71 is disposed to overlap the first portion 61 of the first metal plate 60 from the side opposite to the electronic component 20X.

The third portion 71 has an attachment hole 71h. The attachment hole 71h is a through hole penetrating the third portion 71 in the X direction. The attachment hole 71h communicates with the attachment hole 61h of the first metal plate 60 in the X direction, and faces the terminal 23 of the electronic component 20X in the X direction. The attachment hole 71h does not have, for example, screw grooves. The attachment hole 71h receives insertion of the fastening member 31. The third portion 71 is fixed to the terminal 23 of the electronic component 20X by engagement of the fastening member 31 that has passed through the attachment hole 71h of the second metal plate 70 and the attachment hole 61h of the first metal plate 60 with the attachment hole 23h of the terminal 23 of the electronic component 20X. In other words, the third portion 71 of the second metal plate 70 is fastened together with the first portion 61 of the first metal plate 60 and the terminal 23 of the electronic component 20X by the fastening member 31.

### Fourth Portion

The fourth portion 72 is bent in the -X direction from an end of the third portion 71 at the -Z direction side and extends along the X direction. The fourth portion 72 has a plate shape extending along the X direction and the Y direction. The fourth portion 72 extends along the second portion 62 of the first metal plate 60 (see FIG. 4). The fourth portion 72 at least partially overlaps the bus bar 40 when viewed from the Z direction (see FIG. 4). The fourth portion 72 is disposed to overlap the second portion 62 of the first metal plate 60 from the side opposite to the bus bar 40.

The fourth portion 72 has an attachment hole 72h. The attachment hole 72h is a through hole penetrating the fourth portion 72 in the Z direction. The attachment hole 72h does not have, for example, screw grooves. The attachment hole 72h receives insertion of the fastening member 43 (see FIG. 5). The fourth portion 72 is fixed to the bus bar 40 by engaging an engagement member 44 (for example, a nut) with a tip portion of the fastening member 43 that has passed through the attachment hole 62h of the first metal plate 60 and the attachment hole 72h of the second metal plate 70. In other words, the fourth portion 72 of the second metal plate 70 is fastened together with the second portion 62 of the first metal plate 60 and the bus bar 40 by the fastening member 43.

### Arcuate Portion

At the boundary between the third portion 71 and the fourth portion 72, an arcuate portion 73 is formed by bending the fourth portion 72 with respect to the third portion 71. The arcuate portion 73 is formed in an arcuate shape having a second curvature radius. The second curvature radius is, for example, smaller than the first curvature radius of the arcuate portion 63 of the first metal plate 60. The arcuate portion 73 of the second metal plate 70 is disposed to overlap the arcuate portion 63 of the first metal plate 60.

### 6.4 Shapes of First Metal Plate and Second Metal Plate

FIG. 5 is a cross-sectional view illustrating a part of the electrical connection unit 1. The first portion 61 of the first metal plate 60 has a first end E1 located on the side opposite to the bus bar 40. Similarly, the third portion 71 of the second metal plate 70 has a second end E2 located on the side opposite to the bus bar 40. In addition, in the present embodiment, the positions of the first end E1 and the second end E2 in the Z direction are the same.

In addition, the second portion 62 of the first metal plate 60 has a third end E3 located on the side opposite to the electronic component 20X. Similarly, the fourth portion 72 of the second metal plate 70 has a fourth end E4 located on the side opposite to the electronic component 20X. In addition, in the present embodiment, the positions of the third end E3 and the fourth end E4 in the X direction are the same.

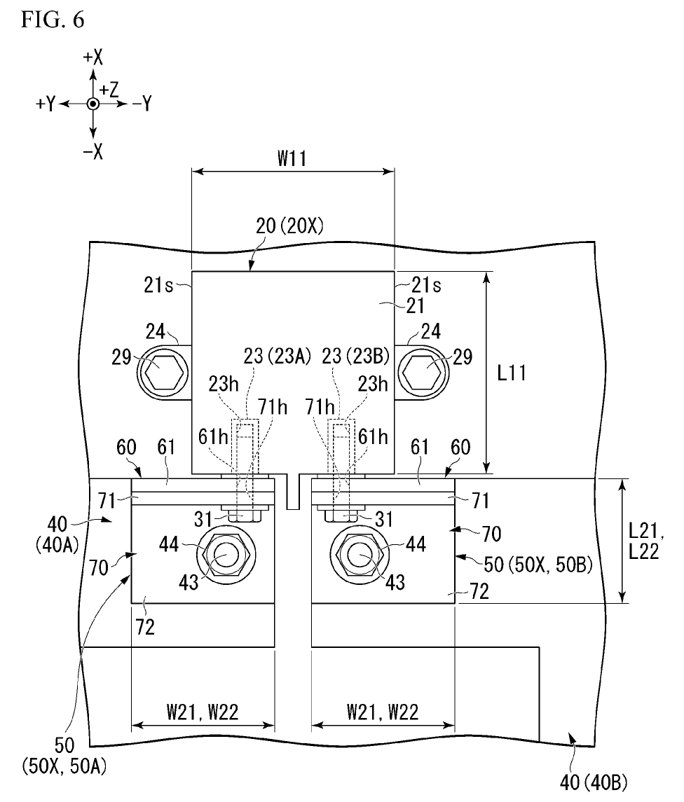

FIG. 6 is a plan view illustrating a part of the electrical connection unit 1. In the present embodiment, a length L21 of the first metal plate 60 in the X direction and a length L22 of the second metal plate 70 in the X direction are equal. In addition, each of the length L21 of the first metal plate 60 in the X direction and the length L22 of the second metal plate 70 in the X direction are smaller than a length L11 of the electronic component 20X in the X direction.

In the present embodiment, a length (width) W21 of the first metal plate 60 in the Y direction is equal to a length (width) W22 of the second metal plate 70 in the Y direction. Further, each of the length (width) W21 of the first metal plate 60 in the Y direction and the length (width) W22 of the second metal plate 70 in the Y direction is greater than half of a width W11 of the electronic component 20X in the Y direction.

In the present embodiment, each of the first metal plate 60 and the second metal plate 70 extends beyond a side surface 21s of the electronic component 20X in the Y direction. For example, the first portion 61 and the second portion 62 of the first metal plate 60 included in a first connection component 50A to be described below and the third portion 71 and the fourth portion 72 of the second metal plate 70 included in the first connection component 50A extend in the +Y direction beyond the side surface 21s of the electronic component 20X on the +Y direction side. That is, the first portion 61 and the second portion 62 of the first metal plate 60 included in the first connection component 50A and the third portion 71 and the fourth portion 72 of the second metal plate 70 included in the first connection component 50A protrude toward the +Y direction side from the side surface 21s of the electronic component 20X on the +Y direction side.

On the other hand, the first portion 61 and the second portion 62 of the first metal plate 60 included in the second connection component 50B to be described below and the third portion 71 and the fourth portion 72 of the second metal plate 70 included in the second connection component 50B extend in the -Y direction beyond the side surface 21s of the electronic component 20X on the -Y direction side. That is, the first portion 61 and the second portion 62 of the first metal plate 60 included in the second connection component 50B and the third portion 71 and the fourth portion 72 of the second metal plate 70 included in the second connection component 50B protrude toward the -Y direction side from the side surface 21s of the electronic component 20X at the -Y direction side.

### 6.5 Disposition Relationship of a Plurality of Connection Components

Next, a disposition relationship of the plurality of connection components 50 will be described with reference to FIG. 4. In the present embodiment, two connection components 50 (first connection component 50A and second connection component 50B) are disposed for one electronic component 20X.

The first connection component 50A is a connection component corresponding to the terminal 23A of the electronic component 20X. The first metal plate 60 and the second metal plate 70 of the first connection component 50A are fastened together with the terminal 23A of the electronic component 20X by the fastening member 31 (fastening member 31A). The first metal plate 60 and the second metal plate 70 of the first connection component 50A are fastened together with a first bus bar 40A by the fastening member 43 (fastening member 43A). With this configuration, the first connection component 50A physically and electrically connects the terminal 23A of the electronic component 20X and the first bus bar 40A.

The second connection component 50B is disposed side by side with respect to the first connection component 50A in the Y direction. For example, the second connection component 50B is positioned at the -Y direction side with respect to the first connection component 50A. The second connection component 50B is a connection component corresponding to the terminal 23B of the electronic component 20X. The first metal plate 60 and the second metal plate 70 of the second connection component 50B are fastened together with the terminal 23B of the electronic component 20X by the fastening member 31 (fastening member 31B). The first metal plate 60 and the second metal plate 70 of the second connection component 50B are fastened together with the second bus bar 40B by the fastening member 43 (fastening member 43B). With this configuration, the second connection component 50B physically and electrically connects the terminal 23B of the electronic component 20X and the second bus bar 40B.

### 6.6 Modification of First Aspect

Next, a modification of the connection component 50X of a first aspect will be described.

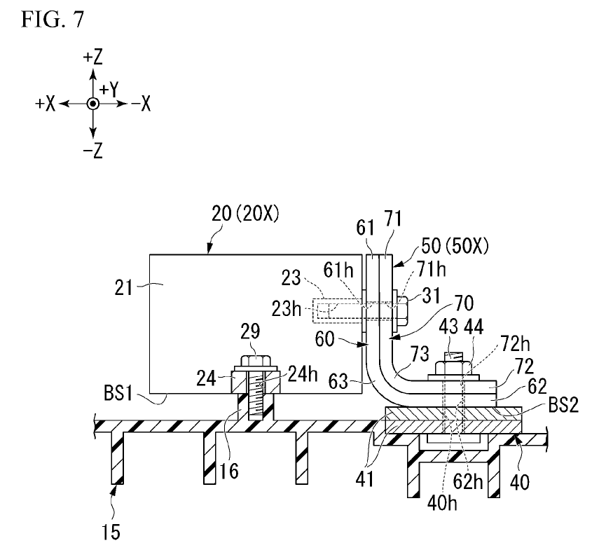

FIG. 7 is a cross-sectional view illustrating a modification of the electrical connection unit 1 of the first aspect. Here, depending on the material or thickness of the first metal plate 60 or the second metal plate 70, the curvature radii of the arcuate portion 63 and the arcuate portion 73 may increase. In addition, the fastening member 31 may become large in order to secure a fastening force for fixing the plurality of metal plates 60 and 70 to the electronic component 20X. In any of these cases, the distance between the arcuate portion 73 of the second metal plate 70 and the fastening member 31 becomes shorter, and in some cases, the arcuate portion 73 of the second metal plate 70 and the fastening member 31 may interfere with each other.

Therefore, in the present modification, a lower surface BS2 of the connection component 50X (the contact surface between the connection component 50X and the bus bar 40) is disposed below a lower surface BS1 of the electronic component 20X. According to such a configuration, the distance between the arcuate portion 73 of the second metal plate 70 and the fastening member 31 increases and even when the arcuate portion 73 is large and/or the fastening member 31 increases in size, interference between the arcuate portion 73 of the second metal plate 70 and the fastening member 31 can be suppressed.

### 6.7 Advantages of Connection Component of First Aspect

As a comparative example, in order to improve thermal characteristics (for example, heat storage property and/or heat dissipation property) of the electrical connection unit, a case is considered in which an L-shaped metal block (heat storage block) is used as a connection component for connecting the electronic components and the wiring members. Such a metal block is generally a forged product and is often expensive. Therefore, as a connection component for connecting the electronic components and the wiring members, it is conceivable to use a metal plate that is inexpensive as compared with a forged product by bending the metal plate. However, the thickness of an available metal plate is limited, and it may be difficult to sufficiently secure the heat capacity.

Therefore, in the present embodiment, the connection component (for example, the connection component 50) includes a first metal plate (for example, the first metal plate 60) and a second metal plate (for example, the second metal plate 70). The first metal plate includes a first portion (for example, the first portion 61) and a second portion (for example, the second portion 62). The first portion is fixed to the terminal of an electronic component (for example, the terminal 23A of the electronic component 20X) by a first fastening member (for example, the fastening member 31). The second portion is bent from the first portion and fixed to the wiring member (for example, the bus bar 40) by a second fastening member (for example, the fastening member 43). The second metal plate includes a third portion (for example, the third portion 71) and a fourth portion (for example, the fourth portion 72). The third portion is disposed to overlap the first portion and is fastened together with the terminal by the first fastening member. The fourth portion is bent from the third portion, disposed overlapping the second portion, and is fastened together with the wiring member by the second fastening member.

According to such a configuration, it is possible to form a connection component that connects an electronic component and a wiring member by stacking two metal plates. With this configuration, it is easy to secure a sufficient heat capacity while using a metal plate that is inexpensive as compared with a forged product. As a result, it is possible to improve the thermal characteristics (for example, heat storage property and/or heat dissipation property) of the electrical connection unit and to reduce the cost.

In the present embodiment, the terminal is open in the first direction. The wiring member is positioned away from the terminal in a second direction intersecting the first direction. The first portion of the first metal plate and the third portion of the second metal plate at least partially overlap the electronic component when viewed from the first direction and extend in the second direction. The second portion of the first metal plate and the fourth portion of the second metal plate at least partially overlap the wiring member when viewed from the second direction and extend in the first direction. According to such a configuration, in a configuration in which the terminal of the electronic component and the wiring member are separated in a direction different from the opening direction of the terminal of the electronic component, it is possible to form a connection component that connects the electronic component and the wiring member by stacking two metal plates.

In the present embodiment, the first portion of the first metal plate has a first end (for example, a first end E1) located on the side opposite to the wiring member. The third portion of the second metal plate has a second end (for example, a second end E2) located on the side opposite to the wiring member. The positions of the first end and the second end in the second direction are the same. According to such a configuration, it is possible to reduce the size of the connection component while increasing the heat capacity of the connection component as compared with the case where the first end and the second end are misaligned. With this configuration, the electrical connection unit can be downsized.

In the present embodiment, the second portion of the first metal plate has a third end (for example, a third end E3) located on the side opposite to the electronic component. The fourth portion of the second metal plate has a fourth end (for example, a fourth end E4) located on the side opposite to the electronic component. The positions of the third end and the fourth end in the first direction are the same. According to such a configuration, it is possible to reduce the size of the connection component while increasing the heat capacity of the connection component as compared with the case where the third end and the fourth end are misaligned. With this configuration, the electrical connection unit can be downsized.

In the present embodiment, the first metal plate and the second metal plate extend beyond the side surface (for example, the side surface 21s) of the electronic component in the third direction. According to such a configuration, it is easy to secure a large heat capacity of the connection component. With this configuration, the thermal characteristics of the electrical connection unit can be further improved.

### 7. Connection Component of Second Aspect

Next, the connection component 50Y of a second aspect will be described. The connection component 50Y of the second aspect is different from the connection component 50X of the first aspect in that a bent portion is added to the connection component 50X of the first aspect. Note that the configuration of the connection component 50Y of the second aspect other than that described below is the same as the configuration of the connection component 50X of the first aspect described above.

### 7.1 Example 1 of Connection Component of Second Aspect

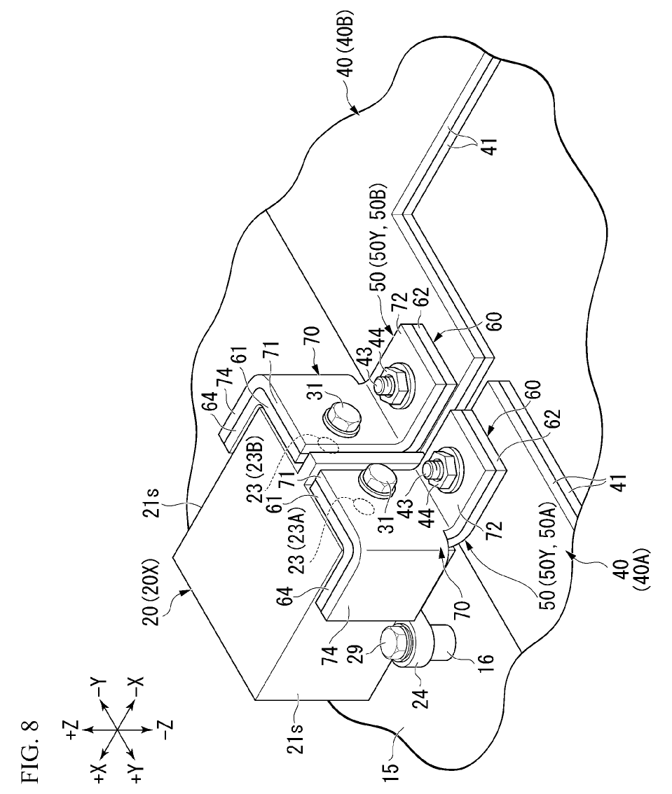

FIG. 8 is a perspective view for explaining Example 1 of the connection component 50Y of the second aspect. The connection component 50Y of Example 1 includes a first metal plate 60 and a second metal plate 70. The connection component 50Y is formed by overlapping the first metal plate 60 and the second metal plate 70.

### First Metal Plate

The first metal plate 60 includes a first portion 61 and a second portion 62. In Example 1, an end of the first portion 61 in the horizontal direction (for example, the Y direction) has a bent portion 64. For example, the bent portion 64 included in the first connection component 50A is bent from the end of the first portion 61 on the +Y direction side toward the +X direction side and extends along the X direction. On the other hand, the bent portion 64 included in the second connection component 50B is bent toward the +X direction side from the end of the first portion 61 on the -Y direction side and extends along the X direction. The bent portion 64 has a plate shape extending along the X direction and the Z direction. The bent portion 64 extends along the side surface 21s of the electronic component 20X. In the example illustrated in FIG. 8, the bent portion 64 is disposed in the vicinity of the electronic component 20X. The bent portion 64 at least partially overlaps the electronic component 20X when viewed from the Y direction. The bent portion 64 is an example of a “first bent portion”. Note that, similarly to the connection component 50X of the first aspect, the first portion 61 and the second portion 62 of the first metal plate 60 may extend beyond the side surface 21s of the electronic component 20X in the Y direction. That is, the bent portion 64 is not limited to being disposed in the vicinity of the electronic component 20X, and may be disposed away from the vicinity of the electronic component 20X.

### Second Metal Plate

The second metal plate 70 includes a third portion 71 and a fourth portion 72. In Example 1, an end of the third portion 71 in the horizontal direction (for example, the Y direction) has a bent portion 74. For example, the bent portion 74 included in the first connection component 50A is bent from the end of the third portion 71 on the +Y direction side toward the +X direction side and extends along the X direction. On the other hand, the bent portion 74 included in the second connection component 50B is bent from the end of the third portion 71 on the -Y direction side toward the +X direction side and extends along the X direction. That is, in Example 1, the bent portion 64 and the bent portion 74 are bent in the same direction. The bent portion 74 has a plate shape extending along the X direction and the Z direction. In the example illustrated in FIG. 8, the bent portion 74 is disposed in the vicinity of the electronic component 20X. The bent portion 74 of the second metal plate 70 overlaps the bent portion 64 of the first metal plate 60 from the side opposite to the electronic component 20X. The bent portion 74 is an example of a “second bent portion”. Note that, similarly to the connection component 50X of the first aspect, the third portion 71 and the fourth portion 72 of the second metal plate 70 may extend beyond the side surface 21s of the electronic component 20X in the Y direction. That is, the bent portion 74 is not limited to being disposed in the vicinity of the electronic component 20X, and may be disposed away from the vicinity of the electronic component 20X.

### 7.2 Example 2 of Connection Component of Second Aspect

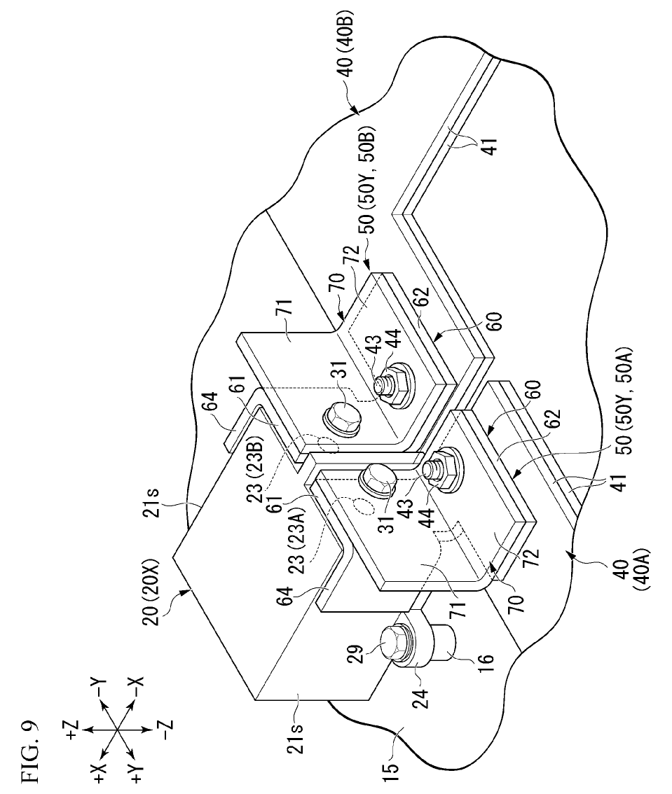

FIG. 9 is a perspective view for explaining Example 2 of the connection component 50Y of the second aspect. The connection component 50Y of Example 2 includes a first metal plate 60 and a second metal plate 70. The connection component 50Y is formed by overlapping the first metal plate 60 and the second metal plate 70.

### First Metal Plate

The first metal plate 60 includes a first portion 61 and a second portion 62. In Example 2, the end of the first portion 61 in the horizontal direction (for example, the Y direction) has a bent portion 64 as in Example 1. For example, the bent portion 64 included in the first connection component 50A is bent from the end of the first portion 61 on the +Y direction side toward the +X direction side and extends along the X direction. On the other hand, the bent portion 64 included in the second connection component 50B is bent toward the +X direction side from the end of the first portion 61 on the -Y direction side and extends along the X direction. The bent portion 64 extends along the side surface 21s of the electronic component 20X. In the example illustrated in FIG. 9, the bent portion 64 is disposed in the vicinity of the electronic component 20X. The bent portion 64 is an example of a “first bent portion”. Note that, similarly to the connection component 50X of the first aspect, the first portion 61 of the first metal plate 60 may extend beyond the side surface 21s of the electronic component 20X in the Y direction. That is, the bent portion 64 is not limited to being disposed in the vicinity of the electronic component 20X, and may be disposed away from the vicinity of the electronic component 20X.

In the present example, the second portion 62 extends to a position beyond the bent portion 64 in the Y direction that is the direction away from the electronic component 20X. For example, the second portion 62 included in the first connection component 50A extends in the +Y direction beyond the bent portion 64. On the other hand, the second portion 62 included in the second connection component 50B extends in the -Y direction beyond the bent portion 64. Note that, instead of the above example, the second portion 62 may not extend in the Y direction beyond the bent portion 64. A length (width) of the second portion 62 in the Y direction may be the same as a length (width) of the first portion 61 in the Y direction.

### Second Metal Plate

The second metal plate 70 includes a third portion 71 and a fourth portion 72. In Example 2 of the connection component 50Y, the bent portion 74 is not provided. The second metal plate 70 has the same shape as the second metal plate 70 of the first aspect described above.

In the present example, the third portion 71 of the second metal plate 70 extends to a position beyond the bent portion 64 in the Y direction that is the direction away from the electronic component 20X. For example, the third portion 71 included in the first connection component 50A extends in the +Y direction beyond the bent portion 64. On the other hand, the third portion 71 included in the second connection component 50B extends in the -Y direction beyond the bent portion 64. That is, the third portion 71 of the second metal plate 70 includes a portion not overlapping the first metal plate 60. According to this configuration, the heat dissipation area exposed to air in the connection component 50Y increases.

Similarly, the fourth portion 72 of the second metal plate 70 extends to a position beyond the bent portion 64 in the Y direction that is the direction away from the electronic component 20X. For example, the fourth portion 72 included in the first connection component 50A extends in the +Y direction beyond the bent portion 64. On the other hand, the fourth portion 72 included in the second connection component 50B extends in the -Y direction beyond the bent portion 64.

Note that, instead of the above example, the second metal plate 70 may not extend in the Y direction beyond the bent portion 64. A length (width) of the second metal plate 70 in the Y direction may be the same as a length (width) of the first portion 61 of the first metal plate 60 in the Y direction.

### 7.3 Example 3 of Connection Component of Second Aspect

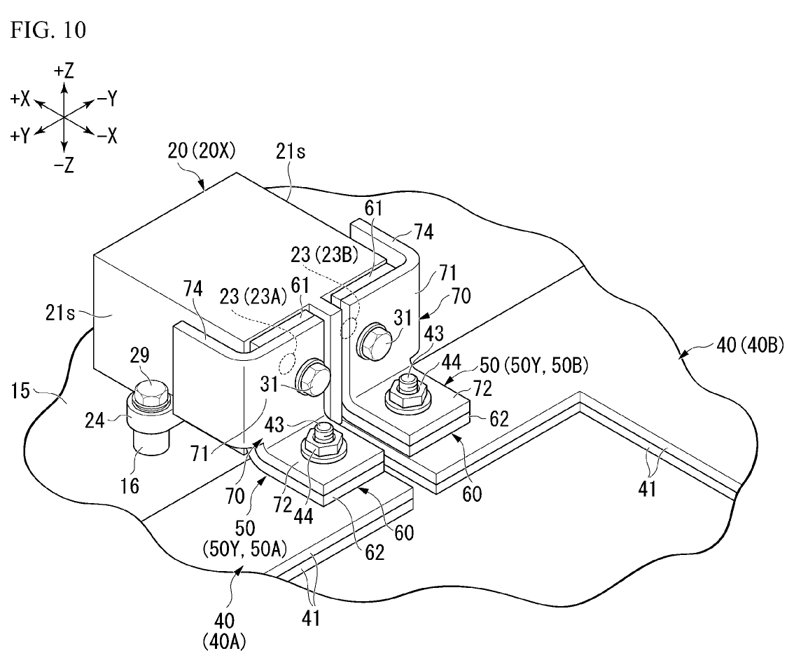

FIG. 10 is a perspective view for explaining Example 3 of the connection component 50Y of the second aspect. The connection component 50Y of Example 3 includes a first metal plate 60 and a second metal plate 70. The connection component 50Y is formed by overlapping the first metal plate 60 and the second metal plate 70.

### First Metal Plate

The first metal plate 60 includes a first portion 61 and a second portion 62. In Example 3, the bent portion 64 is not provided. The first metal plate 60 has the same shape as the first metal plate 60 of the first aspect described above.

### Second Metal Plate

The second metal plate 70 includes a third portion 71 and a fourth portion 72. In Example 3, the end of the third portion 71 in the horizontal direction (for example, the Y direction) has a bent portion 74 as in Example 1. For example, the bent portion 74 included in the first connection component 50A is bent from the end of the third portion 71 on the +Y direction side toward the +X direction side and extends along the X direction. On the other hand, the bent portion 74 included in the second connection component 50B is bent from the end of the third portion 71 on the -Y direction side toward the +X direction side and extends along the X direction. The bent portion 74 is an example of a “first bent portion”.

### 7.4 Example 4 of Connection Component of Second Aspect

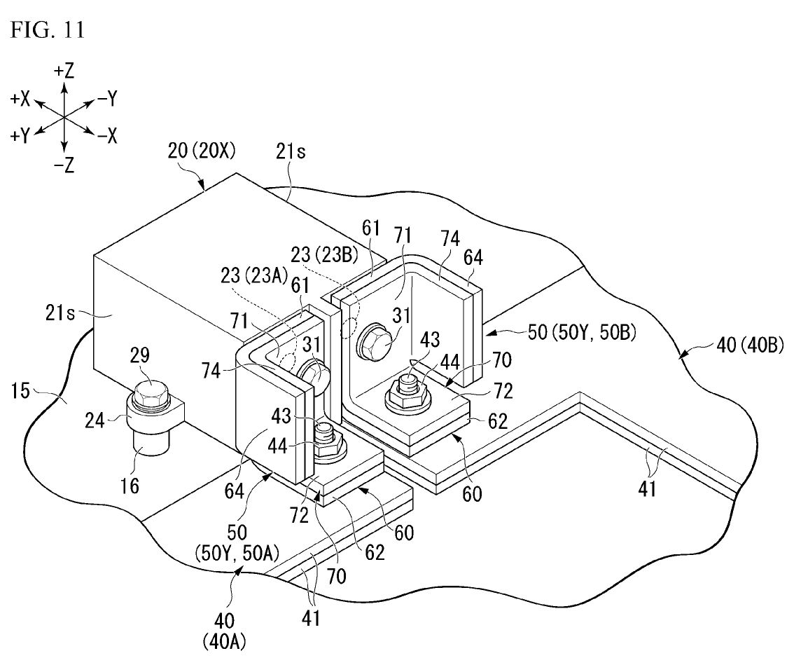

FIG. 11 is a perspective view for explaining Example 4 of the connection component 50Y of the second aspect. The connection component 50Y of Example 4

includes a first metal plate 60 and a second metal plate 70. The connection component 50Y is formed by overlapping the first metal plate 60 and the second metal plate 70.

### First Metal Plate

The first metal plate 60 includes a first portion 61 and a second portion 62. In Example 4, an end of the first portion 61 in the horizontal direction (for example, the Y direction) has a bent portion 64. For example, the bent portion 64 included in the first connection component 50A is bent from the end of the first portion 61 on the +Y direction side toward the -X direction side and extends along the X direction. On the other hand, the bent portion 64 included in the second connection component 50B is bent from the end of the first portion 61 on the -Y direction side toward the -X direction side and extends along the X direction. The bent portion 64 has a plate shape extending along the X direction and the Z direction. The bent portion 64 at least partially overlaps the fastening member 31 when viewed from the Y direction. The bent portion 64 is an example of a “first bent portion”. Note that, similarly to the connection component 50X of the first aspect, the first portion 61 and the second portion 62 of the first metal plate 60 may extend beyond the side surface 21s of the electronic component 20X in the Y direction.

### Second Metal Plate

The second metal plate 70 includes a third portion 71 and a fourth portion 72. In Example 4, an end of the third portion 71 in the horizontal direction (for example, the Y direction) has a bent portion 74. For example, the bent portion 74 included in the first connection component 50A is bent from the end of the third portion 71 on the +Y direction side toward the -X direction side and extends along the X direction. On the other hand, the bent portion 74 included in the second connection component 50B is bent from the end of the third portion 71 on the -Y direction side toward the -X direction side and extends along the X direction. That is, in Example 4, the bent portion 64 and the bent portion 74 are bent in the same direction. The bent portion 74 has a plate shape extending along the X direction and the Z direction. The bent portion 74 of the second metal plate 70 overlaps the bent portion 64 of the first metal plate 60 from the side opposite to the fastening member 31. The bent portion 74 is an example of a “second bent portion”. Note that, similarly to the connection component 50X of the first aspect, the third portion 71 and the fourth portion 72 of the second metal plate 70 may extend beyond the side surface 21s of the electronic component 20X in the Y direction.

### 7.5 Example 5 of Connection Component of Second Aspect

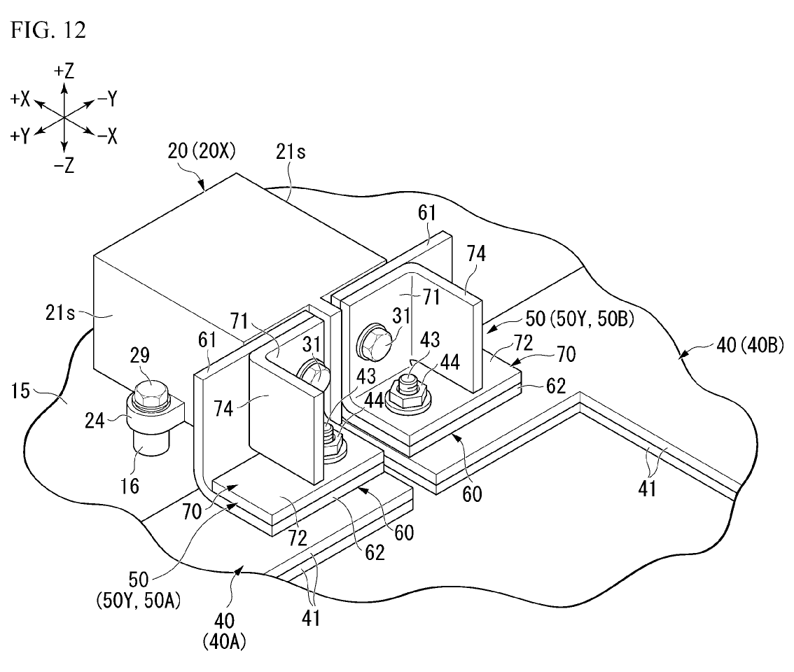

FIG. 12 is a perspective view for explaining Example 5 of the connection component 50Y of the second aspect. The connection component 50Y of Example 5 includes a first metal plate 60 and a second metal plate 70. The connection component 50Y is formed by overlapping the first metal plate 60 and the second metal plate 70.

### First Metal Plate

The first metal plate 60 includes a first portion 61 and a second portion 62. In Example 5 of the connection component 50Y, the bent portion 64 is not provided. The first metal plate 60 has the same shape as the first metal plate 60 of the first aspect described above.

In the present example, the first portion 61 of the first metal plate 60 extends to a position beyond the bent portion 74 of the second metal plate 70 in the Y direction that is the direction away from the electronic component 20X. For example, the first portion 61 included in the first connection component 50A extends in the +Y direction beyond the bent portion 74 of the second metal plate 70. On the other hand, the first portion 61 included in the second connection component 50B extends in the -Y direction beyond the bent portion 74 of the second metal plate 70. That is, the first portion 61 of the first metal plate 60 includes a portion not overlapping the second metal plate 70. According to this configuration, the heat dissipation area exposed to air in the connection component 50Y increases.

Similarly, the second portion 62 of the first metal plate 60 extends to a position beyond the bent portion 74 of the second metal plate 70 in the Y direction that is the direction away from the electronic component 20X. For example, the second portion 62 included in the first connection component 50A extends in the +Y direction beyond the bent portion 74 of the second metal plate 70. On the other hand, the second portion 62 included in the second connection component 50B extends in the -Y direction beyond the bent portion 74 of the second metal plate 70.

Note that, instead of the above example, the first metal plate 60 may not extend in the Y direction beyond the bent portion 74 of the second metal plate 70. A length (width) of the first metal plate 60 in the Y direction may be the same as a length (width) of the third portion 71 of the second metal plate 70 in the Y direction.

### Second Metal Plate

The second metal plate 70 includes a third portion 71 and a fourth portion 72. In Example 5, an end of the third portion 71 in the horizontal direction (for example, the Y direction) has a bent portion 74. For example, the bent portion 74 included in the first connection component 50A is bent from the end of the third portion 71 on the +Y direction side toward the -X direction side and extends along the X direction. On the other hand, the bent portion 74 included in the second connection component 50B is bent from the end of the third portion 71 on the -Y direction side toward the -X direction side and extends along the X direction. The bent portion 74 has a plate shape extending along the X direction and the Z direction. The bent portion 74 is an example of a “first bent portion”. Note that, similarly to the connection component 50X of the first aspect, the third portion 71 of the second metal plate 70 may extend beyond the side surface 21s of the electronic component 20X in the Y direction.

In the present example, the fourth portion 72 extends to a position beyond the bent portion 74 in the Y direction that is a direction away from the electronic component 20X. For example, the fourth portion 72 included in the first connection component 50A extends in the +Y direction beyond the bent portion 74. On the other hand, the fourth portion 72 included in the second connection component 50B extends in the -Y direction beyond the bent portion 74. Note that, instead of the above example, the fourth portion 72 may not extend in the Y direction beyond the bent portion 74. A length (width) of the fourth portion 72 in the Y direction may be the same as a length (width) of the third portion 71 in the Y direction.

### 7.6 Example 6 of Connection Component of Second Aspect

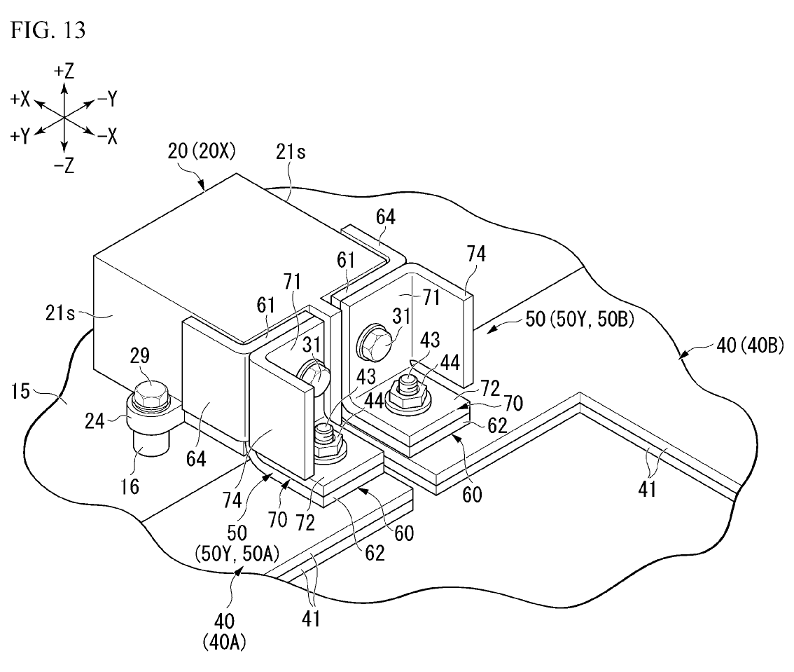

FIG. 13 is a perspective view for explaining Example6 of the connection component 50Y of the second aspect. The connection component 50Y of Example 6 includes a first metal plate 60 and a second metal plate 70. The connection component 50Y is formed by overlapping the first metal plate 60 and the second metal plate 70.

### First Metal Plate

The first metal plate 60 includes a first portion 61 and a second portion 62. In Example 6, an end of the first portion 61 in the horizontal direction (for example, the Y direction) has a bent portion 64. For example, the bent portion 64 included in the first connection component 50A is bent from the end of the first portion 61 on the +Y direction side toward the +X direction side and extends along the X direction. On the other hand, the bent portion 64 included in the second connection component 50B is bent toward the +X direction side from the end of the first portion 61 on the -Y direction side and extends along the X direction. The bent portion 64 has a plate shape extending along the X direction and the Z direction. The bent portion 64 extends along a side surface of the electronic component 20X. The bent portion 64 at least partially overlaps the electronic component 20X when viewed from the Y direction. The bent portion 64 is an example of a “first bent portion”.

### Second Metal Plate

The second metal plate 70 includes a third portion 71 and a fourth portion 72. In Example 4, an end of the third portion 71 in the horizontal direction (for example, the Y direction) has a bent portion 74. For example, the bent portion 74 included in the first connection component 50A is bent from the end of the third portion 71 on the +Y direction side toward the -X direction side and extends along the X direction. On the other hand, the bent portion 74 included in the second connection component 50B is bent from the end of the third portion 71 on the -Y direction side toward the -X direction side and extends along the X direction. That is, in Example 4, the bent portion 64 and the bent portion 74 are bent in different directions (for example, opposite directions). The bent portion 74 has a plate shape extending along the X direction and the Z direction. The bent portion 74 is an example of a “second bent portion”.

Note that, similarly to the connection component 50X of the first aspect, each of the first metal plate 60 and the second metal plate 70 may extend beyond the side surface 21s of the electronic component 20X in the Y direction. That is, the bent portion 64 is not limited to being disposed in the vicinity of the electronic component 20X, and may be disposed away from the vicinity of the electronic component 20X.

### 7.7 Example 7 of Connection Component of Second Aspect

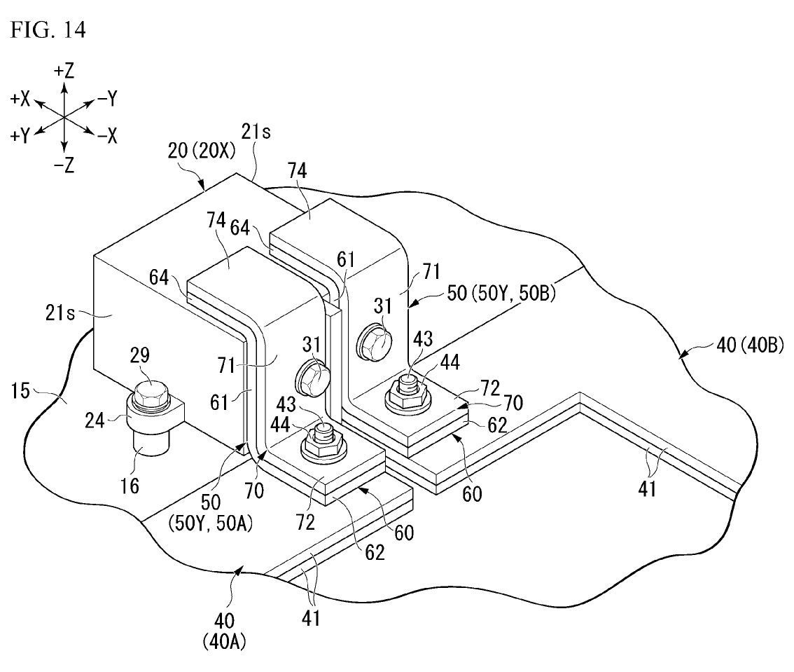

FIG. 14 is a perspective view for explaining Example 7 of the connection component 50Y of the second aspect. The connection component 50Y of Example 7 includes a first metal plate 60 and a second metal plate 70. The connection component 50Y is formed by overlapping the first metal plate 60 and the second metal plate 70.

### First Metal Plate

The first metal plate 60 includes a first portion 61 and a second portion 62. In Example 7, an end of the first portion 61 in the vertical direction (for example, the Z direction) has a bent portion 64. The bent portion 64 is bent toward the +X direction side from an end of the first portion 61 on the +Z direction side and extends along the X direction. The bent portion 64 has a plate shape extending along the X direction and the Y direction. The bent portion 64 extends along the upper surface of the electronic component 20X. The bent portion 64 at least partially overlaps the electronic component 20X when viewed from the Z direction. The bent portion 64 is an example of a “first bent portion”.

### Second Metal Plate

The second metal plate 70 includes a third portion 71 and a fourth portion 72. In Example 7, an end of the third portion 71 in the vertical direction (for example, the Z direction) has a bent portion 74. The bent portion 74 is bent toward the +X direction side from an end of the third portion 71 on the +Z direction side and extends along the X direction. That is, in Example 7, the bent portion 64 and the bent portion 74 are bent in the same direction. The bent portion 74 has a plate shape extending along the X direction and the Y direction. The bent portion 74 of the second metal plate 70 overlaps the bent portion 64 of the first metal plate 60 from the side opposite to the electronic component 20X. The bent portion 74 is an example of a “second bent portion”.

Note that, similarly to the connection component 50X of the first aspect, each of the first metal plate 60 and the second metal plate 70 may extend beyond the side surface 21s of the electronic component 20X in the Y direction. For example, the bent portion 64 and the bent portion 74 may extend beyond the side surface 21s of the electronic component 20X in the Y direction. In addition, the connection component 50Y is not limited to the case of including both the bent portion 64 and the bent portion 74, and may include only one of the bent portion 64 and the bent portion 74.

### 7.8 Example 8 of Connection Component of Second Aspect

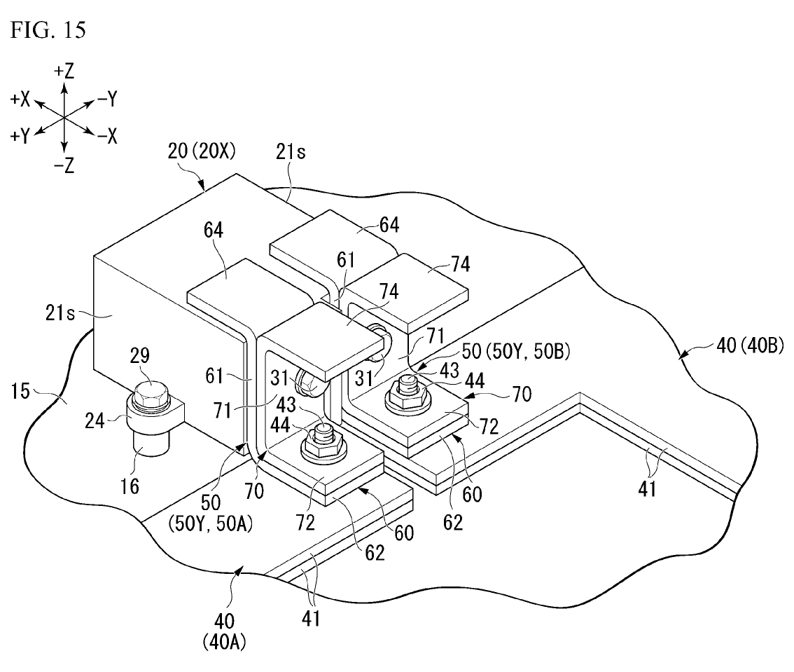

FIG. 15 is a perspective view for explaining Example 8 of the connection component 50Y of the second aspect. The connection component 50Y of Example 8 includes a first metal plate 60 and a second metal plate 70. The connection component 50Y is formed by overlapping the first metal plate 60 and the second metal plate 70.

### First Metal Plate

The first metal plate 60 includes a first portion 61 and a second portion 62. In Example 8, an end of the first portion 61 in the vertical direction (for example, the Z direction) has a bent portion 64. The bent portion 64 is bent toward the +X direction side from an end of the first portion 61 on the +Z direction side and extends along the X direction. The bent portion 64 has a plate shape extending along the X direction and the Y direction. The bent portion 64 extends along the upper surface of the electronic component 20X. The bent portion 64 at least partially overlaps the electronic component 20X when viewed from the Z direction. The bent portion 64 is an example of a “first bent portion”.

### Second Metal Plate

The second metal plate 70 includes a third portion 71 and a fourth portion 72. In Example 8, an end of the third portion 71 in the vertical direction (for example, the Z direction) has a bent portion 74. The bent portion 74 is bent toward the -X direction side from the end of the third portion 71 on the +Z direction side and extends along the X direction. That is, in Example 8, the bent portion 64 and the bent portion 74 are bent in different directions (for example, opposite directions). The bent portion 74 has a plate shape extending along the X direction and the Y direction. The bent portion 74 is an example of a “second bent portion”.

Note that, similarly to the connection component 50X of the first aspect, each of the first metal plate 60 and the second metal plate 70 may extend beyond the side surface 21s of the electronic component 20X in the Y direction. For example, the bent portion 64 and the bent portion 74 may extend beyond the side surface 21s of the electronic component 20X in the Y direction. In addition, the connection component 50Y is not limited to the case of including both the bent portion 64 and the bent portion 74, and may include only one of the bent portion 64 and the bent portion 74.

### 7.9 Advantages of Connection Component of Second Aspect

As a comparative example, a connection component in which two L-shaped metal plates overlap is considered. For example, a connection component in which the bent portions 64 and 74 are not present in the structure illustrated in FIG. 8 is conceivable. In such a connection component, there is room for improvement from the viewpoint of thermal characteristics (heat storage property and/or heat dissipation property).

In the present embodiment, an end of the first metal plate (for example, the first metal plate 60) or an end of the second metal plate (for example, the second metal plate 70) has a first bent portion (for example, the bent portion 64 or the bent portion 74). According to such a configuration, from the first viewpoint, a large heat capacity is secured as compared with a metal plate having no first bent portion, and thermal characteristics (for example, heat storage properties) of the connection component can be improved. In addition, from a second viewpoint, when there is a first bent portion away from another metal plate, as compared with a structure in which two L-shaped metal plates overlap so as to completely coincide with each other, a large heat dissipation area exposed to air is secured, and thermal characteristics (for example, heat dissipation) of the connection component can be improved. By the action of at least one of the first viewpoint or the second viewpoint described above, the thermal characteristics of the electrical connection unit can be improved.

In some examples, the end of the first metal plate has a first bent portion (for example, the bent portion 64). The end of the second metal plate has a second bent portion (for example, the bent portion 74). According to such a configuration, as compared with a configuration in which only one of the first metal plate and the second metal plate has the bent portion, a large heat capacity is secured, and thermal characteristics (for example, heat storage properties) of the connection component can be improved.

In some examples, the second bent portion is disposed to overlap the first bent portion. According to such a configuration, as compared with a case where the first bent portion and the second bent portion are bent in different directions, it is possible to reduce the size of the connection component and/or improve the assemblability.

In some examples, the second bent portion is bent in a direction different from that of the first bent portion. According to such a configuration, as compared with a configuration in which the first bent portion and the second bent portion are disposed in an overlapping manner, it is possible to increase a heat dissipation area in contact with air, and it is easy to improve thermal characteristics (for example, heat dissipation) of the connection component.

In some examples, the first portion of the first metal plate and the third portion of the second metal plate at least partially overlap the electronic component when viewed from the first direction. The first bent portion at least partially overlaps the electronic component when viewed from the second direction different from the first direction. According to such a configuration, the connection component is accommodated around the electronic component, and the electrical connection unit can be easily downsized.

### 8. Connection Component of Third Aspect

Next, a connection component 50Z of the third aspect will be described. The connection component 50Z of the third aspect is different from the connection component 50X of the first aspect in that a second metal plate 80 is fitted to the first metal plate 60. Note that the configuration of the connection component 50Z of the third aspect other than that described below is the same as the configuration of the connection component 50X of the first aspect described above.

### 8.1 Example 1 of Connection Component of Third Aspect

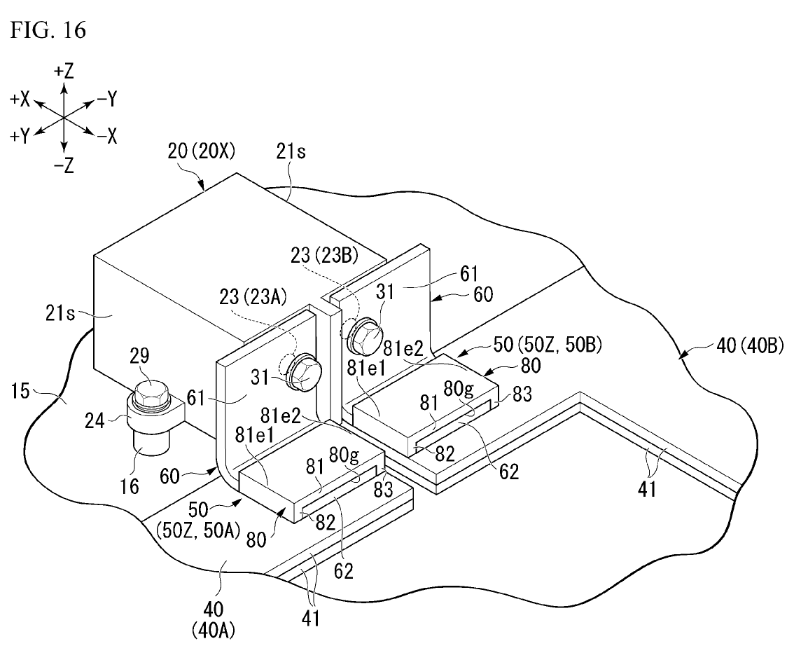

FIG. 16 is a perspective view for explaining Example 1 of the connection component 50Z of the third aspect. The connection component 50Z of Example 1 includes a first metal plate 60 and the second metal plate 80. The connection component 50Z is formed by overlapping the first metal plate 60 and the second metal plate 80.

### First Metal Plate

Similar to the first metal plate 60 of the connection component 50X of the first aspect, the first metal plate 60 includes a first portion 61 and a second portion 62. In the present example, the second portion 62 of the first metal plate 60 is fixed to the bus bar 40 without using the fastening member 43. For example, the second portion 62 of the first metal plate 60 is fixed to the bus bar 40 by welding or rivet fixing. In the case of welding, the second portion 62 of the first metal plate 60 is fixed to the bus bar 40 by, for example, laser welding. In the case of rivet fixing, for example, a hole for fixing is provided in the bus bar 40, and a part of the second portion 62 of the first metal plate 60 is pressed into the hole through press working or the like, whereby the second portion 62 of the first metal plate 60 is fixed to the bus bar 40. The first metal plate 60 is an example of a “first metal member”. Note that the “first metal member” may be a member formed by forging, casting, cutting, or the like, rather than a metal plate.

### Second Metal Plate

The second metal plate 80 is a metal plate attached to the second portion 62 of the first metal plate 60 by fitting. The second metal plate 80 has a recess 80g into which the second portion 62 of the first metal plate 60 is fitted. In addition, the second metal plate 80 is attached to the second portion 62 of the first metal plate 60 by fitting the second portion 62 of the first metal plate 60 into the recess 80g. The second metal plate 80 is an example of a “second metal member”. Note that the “second metal member” may be a member formed by forging, casting, cutting, or the like, rather than a metal plate.

In the present example, the second metal plate 80 includes a base portion 81, a first bent portion 82, and a second bent portion 83. The base portion 81 has a plate shape extending along the X direction and the Y direction. The base portion 81 faces the second portion 62 of the first metal plate 60 from the side opposite to the bus bar 40. The base portion 81 has a first end 81e1 which is the end on the +Y direction side and a second end 81e2 which is the end on the -Y direction side. The second end 81e2 is an end on the side opposite to the first end 81e1 in the Y direction.

The first bent portion 82 is a portion bent from the first end 81e1 of the base portion 81 toward the -Z direction side. The first bent portion 82 extends in the X direction along a side surface (first side surface) of the second portion 62 of the first metal plate 60. The first bent portion 82 is in contact with the first side surface of the second portion 62 of the first metal plate 60 from the +Y direction side.

The second bent portion 83 is a portion bent from the second end 81e2 of the base portion 81 toward the -Z direction side. The second bent portion 83 extends in the X direction along a side surface (second side surface) of the second portion 62 of the first metal plate 60. The second bent portion 83 is positioned on the side opposite to the first bent portion 82 with respect to the second portion 62 of the first metal plate 60. The second bent portion 83 is in contact with the second side surface of the second portion 62 of the first metal plate 60 from the -Y direction side.

In the present example, the recess 80g described above is formed between the first bent portion 82 and the second bent portion 83. In the present example, in the second metal plate 80, the second portion 62 of the first metal plate 60 is inserted into the recess 80g, whereby the second portion 62 of the first metal plate 60 is sandwiched between the first bent portion 82 and the second bent portion 83. With this structure, the second metal plate 80 is fixed to the second portion 62 of the first metal plate 60. In the present example, the second metal plate 80 is disposed to overlap the second portion 62 of the first metal plate 60 from the side opposite to the bus bar 40. The base portion 81 of the second metal plate 80 is contact with the second portion 62 of the first metal plate 60 from the side opposite to the bus bar 40.

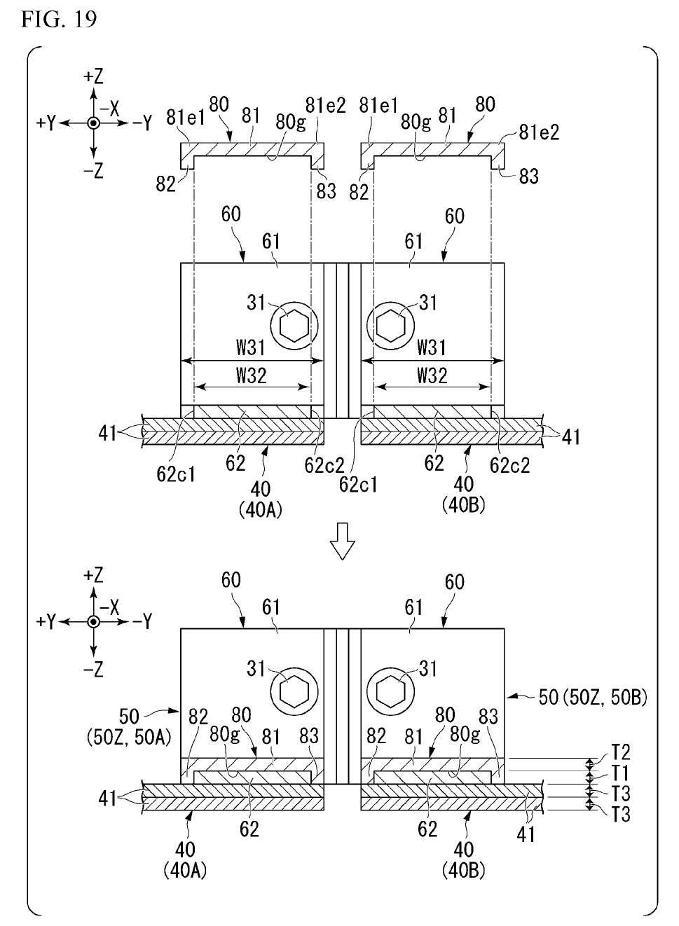

In the present example, the second metal plate 80 has the base portion 81, the first bent portion 82, and the second bent portion 83 by being bent through, for example, press working or the like. In the present example, a plate thickness T1 of the first metal plate 60 and a plate thickness T2 of the second metal plate 80 are equal (see FIG. 19). Each of the plate thickness T1 of the first metal plate 60 and the plate thickness T2 of the second metal plate 80 is, for example, 3 mm. For example, when the thickness and material of the first metal plate 60 and the second metal plate 80 are equal to the thickness and material of the metal plates 41 of the bus bars 40, the metal plates 41, the first metal plate 60, and the second metal plate 80 can be manufactured from the same material. In this case, it is easy to further reduce the manufacturing costs (for example, the material procurement costs) for the electrical connection unit 1.

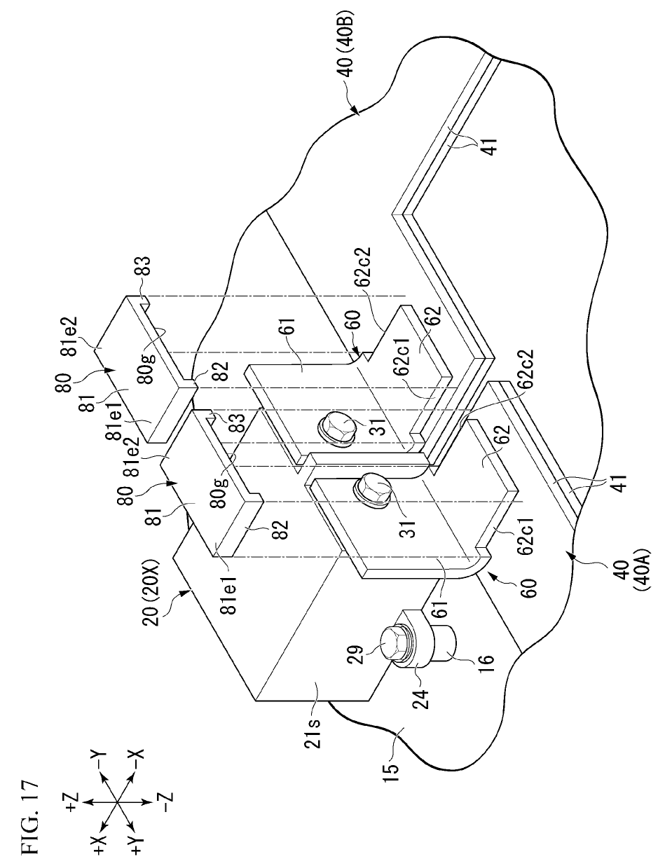

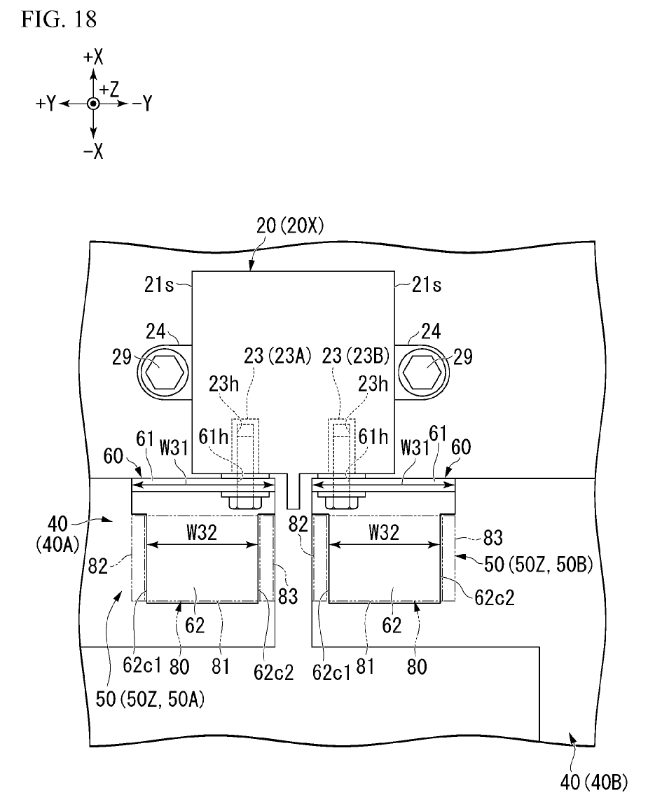

FIG. 17 is a partially exploded perspective view illustrating the electrical connection unit of the third aspect. FIG. 18 is a plan view illustrating a part of the electrical connection unit of the third aspect. In the present example, the second portion 62 of the first metal plate 60 has a first notch 62c1 and a second notch 62c2.

The first notch 62c1 is provided at the end of the second portion 62 of the first metal plate 60 on the +Y direction side. A width of the first notch 62c1 in the Y direction is, for example, equal to a width of the first bent portion 82 of the second metal plate 80 in the Y direction. The first notch 62c1 extends in the X direction. The first bent portion 82 of the second metal plate 80 is disposed in the first notch 62c1.

The second notch 62c2 is provided at the end of the second portion 62 of the first metal plate 60 on the -Y direction side. A width of the second notch 62c2 in the Y direction is, for example, equal to a width of the second bent portion 83 of the second metal plate 80 in the Y direction. The second notch 62c2 extends in the X direction. The second bent portion 83 of the second metal plate 80 is disposed in the second notch 62c2.

FIG. 19 is a cross-sectional view illustrating a part of the electrical connection unit 1 of the third aspect. In the present example, a width W32 of the second portion 62 of the first metal plate 60 in the Y direction is smaller than a width W31 of the first portion 61 of the first metal plate 60 in the Y direction. According to this configuration, even in the structure in which the second metal plate 80 is attached to the second portion 62 of the first metal plate 60, it is easy to secure the gap (insulation distance) between the second metal plate 80 of the first connection component 50A and the second metal plate 80 of the second connection component 50B.

### 8.2 Example 2 of Connection Component of Third Aspect

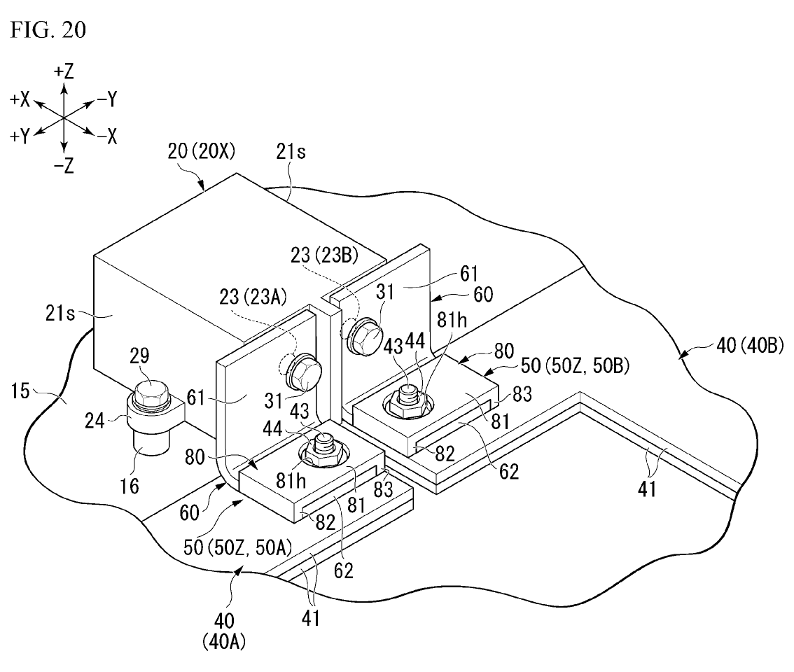

FIG. 20 is a perspective view for explaining Example 2 of the connection component 50Z of the third aspect. The connection component 50Z of Example 2 includes a first metal plate 60 and a second metal plate 80. The connection component 50Z is formed by overlapping the first metal plate 60 and the second metal plate 80.

In the present example, the second portion 62 of the first metal plate 60 is fixed to the bus bar 40 by the fastening member 43, similarly to the connection component 50X of the first aspect. The fastening member 43 protrudes in the +Z direction from the second portion 62 of the first metal plate 60.

In the present example, the base portion 81 of the second metal plate 80 has an opening 81h into which the fastening member 43 and the engagement member 44 are inserted. The outer shape of the opening 81h is larger than the fastening member 43 and the engagement member 44 when viewed from the Z direction. Since the opening 81h is provided, the base portion 81 of the second metal plate 80 is disposed to overlap the second portion 62 of the first metal plate 60 while avoiding interference with the fastening member 43 and the engagement member 44. The opening 81h is an example of an “insertion portion”. Note that the “insertion portion” is not limited to the opening 81h, and may be a notch provided in the base portion 81, or the like.

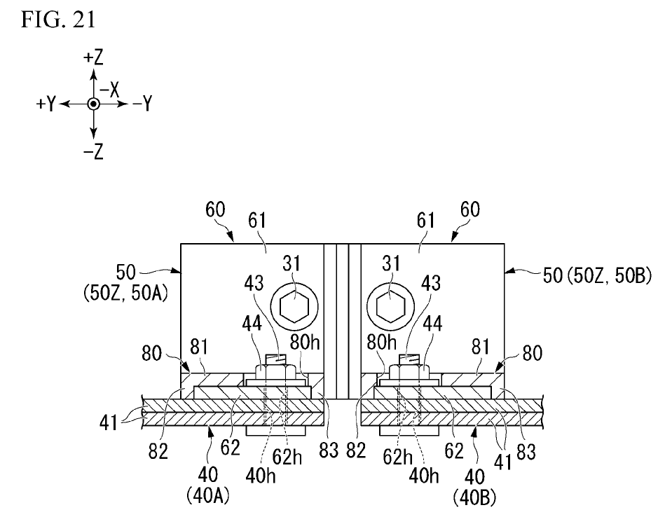

FIG. 21 is a cross-sectional view illustrating a part of the electrical connection unit of the third aspect. In the present example, the base portion 81 of the second metal plate 80 is disposed to overlap the second portion 62 of the first metal plate 60 from the side opposite to the bus bar 40. The base portion 81 of the second metal plate 80 is in contact with the second portion 62 of the first metal plate 60 from the side opposite to the bus bar 40 at a position avoiding the fastening member 43 and the engagement member 44.

### 8.3 Example 3 of Connection Component of Third Aspect

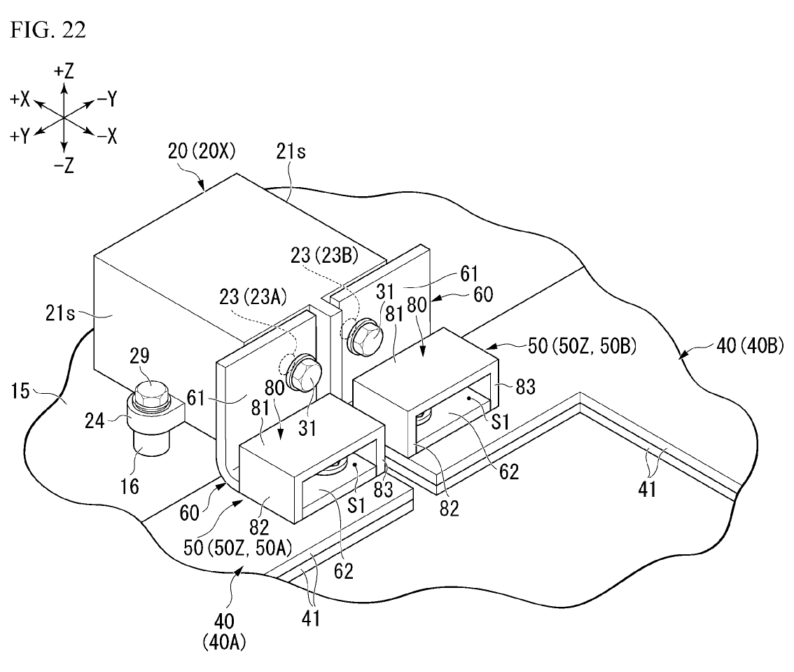

FIG. 22 is a perspective view for explaining Example 3 of the connection component 50Z of the third aspect. The connection component 50Z of Example 3 includes a first metal plate 60 and a second metal plate 80. The connection component 50Z is formed by overlapping the first metal plate 60 and the second metal plate 80.

In the present example, the second portion 62 of the first metal plate 60 is fixed to the bus bar 40 by the fastening member 43, similarly to the connection component 50X of the first aspect. The fastening member 43 protrudes in the +Z direction from the second portion 62 of the first metal plate 60.

In the present example, the base portion 81 of the second metal plate 80 is located on the side opposite to the bus bar 40 with respect to the second portion 62 of the first metal plate 60. The base portion 81 of the second metal plate 80 is disposed away from the second portion 62 of the first metal plate 60 on the +Z direction side. A gap S1 in the Z direction is provided between the base portion 81 of the second metal plate 80 and the second portion 62 of the first metal plate 60. The gap S1 is a space for accommodating a part of the fastening member 43 and the engagement member 44.

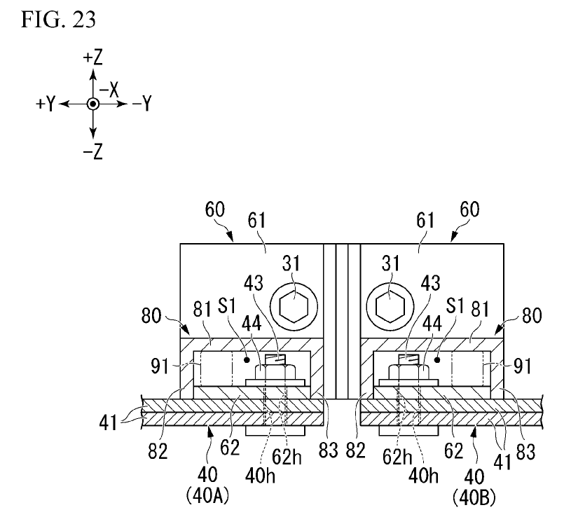

FIG. 23 is a cross-sectional view illustrating a part of the electrical connection unit of the third aspect. As described above, the gap S1 in the Z direction is provided between the base portion 81 of the second metal plate 80 and the second portion 62 of the first metal plate 60. Since the gap S1 is provided, the base portion 81 of the second metal plate 80 is prevented from interfering with the fastening member 43 and the engagement member 44. The gap S1 may be provided with a heat transfer member 91 that thermally connects the base portion 81 of the second metal plate 80 and the second portion 62 of the first metal plate 60. The heat transfer member 91 is, for example, a member formed of a material having better thermal conductivity than the base member 15. The heat transfer member 91 is, for example, an insulating member having elasticity.

### 8.4 Example 4 of Connection Component of Third Aspect

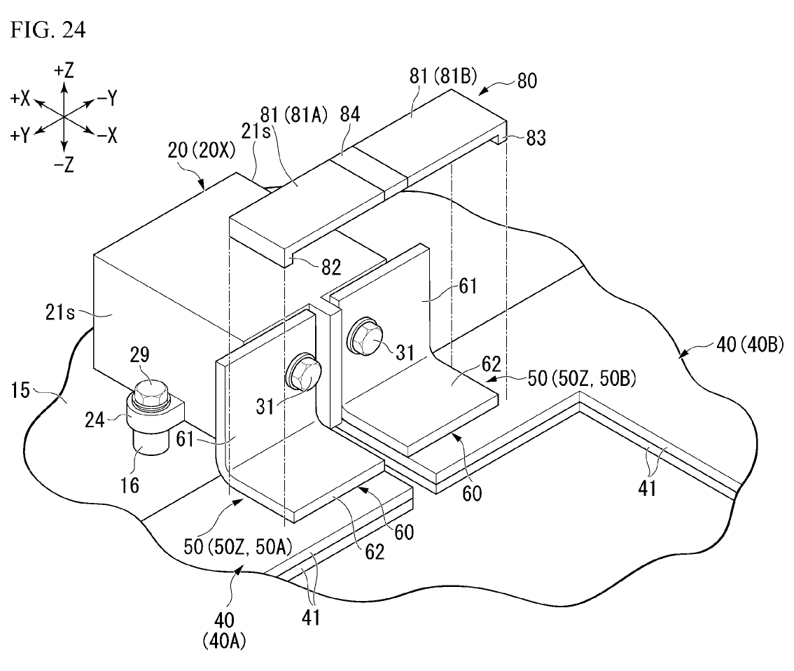

FIG. 24 is a perspective view for explaining Example 4 of the connection component 50Z of the third aspect. The connection component 50Z of Example 4 includes a first metal plate 60 and a second metal plate 80. The connection component 50Z is formed by overlapping the first metal plate 60 and the second metal plate 80.

In the present embodiment, the base portion 81 (first base portion 81A) corresponding to the first connection component 50A and the base portion 81 (second base portion 81B) corresponding to the second connection component 50B are formed by one second metal plate 80. For example, the second metal plate 80 includes a first base portion 81A, a second base portion 81B, a first bent portion 82, a second bent portion 83, and an insulating portion 84.

Each of the first base portion 81A and the second base portion 81B has a plate shape extending along the X direction and the Y direction. The first base portion 81A faces the second portion 62 of the first metal plate 60 of the first connection component 50A from the side opposite to the bus bar 40A. The second base portion 81B faces the second portion 62 of the first metal plate 60 of the second connection component 50B from the side opposite to the bus bar 40B.

The first bent portion 82 is a portion bent from an end of the second metal plate 80 on the +Y direction side toward the -Z direction side. The first bent portion 82 is in contact with the first side surface (the side surface on the +Y direction side) of the second portion 62 of the first metal plate 60 of the first connection component 50A from the +Y direction side.

The second bent portion 83 is a portion bent from an end of the second metal plate 80 on the -Y direction side toward the -Z direction side. The second bent portion 83 is in contact with the second side surface (the side surface on the -Y direction side) of the second portion 62 of the first metal plate 60 of the second connection component 50B from the -Y direction side.

The insulating portion 84 is disposed between the first base portion 81A and the second base portion 81B, and electrically insulates the first base portion 81A and the second base portion 81B from each other. The insulating portion 84 is made of, for example, a synthetic resin. In the present example, a metal plate including the first base portion 81A and the first bent portion 82, a metal plate including the second base portion 81B and the second bent portion 83, and the insulating portion 84 are integrally formed through insert molding or the like.

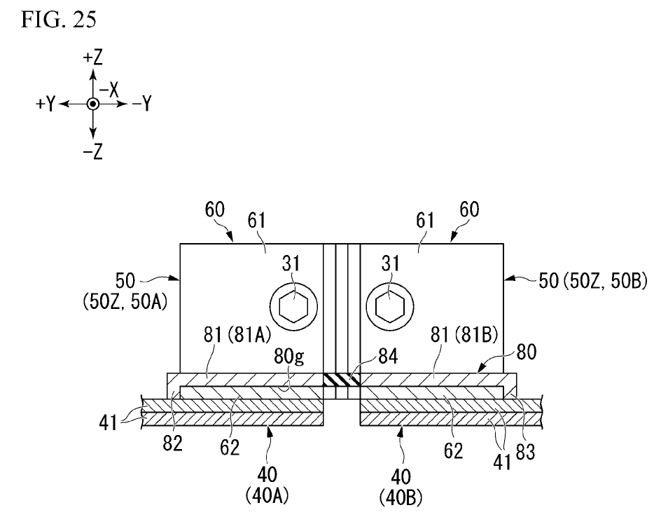

FIG. 25 is a cross-sectional view illustrating a part of the electrical connection unit of the third aspect. In the present example, the second metal plate 80 is attached to the second portion 62 of the first metal plate 60 of the first connection component 50A and the second portion 62 of the first metal plate 60 of the second connection component 50B by fitting. The second metal plate 80 has a recess 80g in which the second portion 62 of the first metal plate 60 of the first connection component 50A and the second portion 62 of the first metal plate 60 of the second connection component 50B are fitted. In addition, the second metal plate 80 is attached to the second portion 62 of the first metal plate 60 by fitting the second portion 62 of the first metal plate 60 of the first connection component 50A and the second portion 62 of the first metal plate 60 of the second connection component 50B into the recess 80g.

Note that the second metal plate 80 of Example 4 is not limited to the above-described example. The second metal plate 80 of Example 4 may have an opening 81h as in Example 2, or a gap S1 may be formed between the second metal plate 80 and the second portion 62 of the first metal plate 60 as in Example 3.

### 8.5 Advantages of Connection Component of Third Aspect

As a comparative example, a connection component in which a second metal member (for example, the second metal plate 80) does not exist will be considered. In such a connection component, there is room for improvement from the viewpoint of thermal characteristics (for example, heat storage property and/or heat dissipation property). In addition, when metal members having thermal characteristics are added by fastening together, there is a possibility that the size of the fastening member increases in order to secure fastening force for fastening a plurality of members.

In the present embodiment, the second metal member (for example, the second metal plate 80) has a recess (for example, the recess 80g) into which the second portion (for example, the second portion 62 of the first metal plate 60) of the first metal member is fitted. The second metal member is attached to the second portion of the first metal member.

According to such a configuration, since the second metal member is present in addition to the first metal member, thermal characteristics (for example, heat storage property and/or heat dissipation property) of the connection component can be improved. With this configuration, it is possible to improve thermal characteristics (for example, heat storage property and/or heat dissipation property) of the electrical connection unit. According to the above configuration, since the first metal member and the second metal member are not fixed to the wiring member by fastening together, it is possible to suppress an increase in size of the fastening member. With this configuration, it is possible to reduce the size and/or cost of the electrical connection unit as compared with a structure in which the first metal member and the second metal member are fastened together to the wiring member.

In the present embodiment, the first metal member is a metal plate having a base portion (for example, the base portion 81), a first bent portion (for example, the first bent portion 82) bent from a first end of the base portion, and a second bent portion (for example, the second bent portion 83) bent from a second end of the base portion opposite to the first end and forming the recess between the first bent portion and itself. According to such a configuration, the second metal member can be formed of a metal plate. In this case, the cost of the electrical connection unit can be reduced as compared with the case where the second metal member is a forged product.

In at least one example, the second portion is fixed to the wiring member (for example, the bus bar 40) by welding or rivet fixing. The second metal member is disposed to overlap the second portion from the side opposite to the wiring member. According to such a configuration, it is easy to dispose the second metal member near the first metal component, and it is easy to enhance the thermal conductivity between the second metal member and the first metal component. With this configuration, the thermal characteristics of the electrical connection unit can be further improved.

In at least one example, the second portion is fixed to the wiring member by a second fastening member. The metal member has an insertion portion (for example, the opening 81h) through which the second fastening member passes. According to such a configuration, it is easy to dispose the second metal member near the first metal component, and it is easy to enhance the thermal conductivity between the second metal member and the first metal component. This makes it possible to further improve the thermal characteristics of the electrical connection unit.

In at least one example, the second portion is fixed to the wiring member by a second fastening member (for example, the fastening member 43). The second metal member has a base portion located on the side opposite to the wiring member with respect to the second portion, and is attached to the second portion with a gap (for example, the gap S1) for accommodating a part of the second fastening member between the second portion and the base portion. According to such a configuration, the second metal member can be disposed while avoiding interference with the fastening member. In addition, when there is the gap, the heat dissipation area of the connection component can be increased.

Several embodiments and modifications have been described above. However, the embodiments and the modifications are not limited to the examples described above. For example, the connection components 50 of the first to third aspects described above may be realized in combination with each other. In addition, each of the modifications of the first to third aspects described above may be realized in combination with each other.

While preferred embodiments of the invention have been described and illustrated above, it should be understood that these are exemplary examples of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

### REFERENCE SIGNS LIST

1 Electrical connection unit

20, 20X, 20A, 20B Electronic component

31 Fastening member (first fastening member)

40 Bus bar (wiring member)

43 Fastening member (second fastening member)

44 Engagement member

50, 50X, 50Y, 50Z Connection component

60 First metal plate (first metal member)

61 First portion

61h Attachment hole

62 Second portion

62h Attachment hole

70 Second metal plate

71 Third portion

71h Attachment hole

72 Fourth portion

72h Attachment hole

80 Second metal plate (second metal member)

80g Groove

81 Base portion

81h Opening (insertion portion)

82 First bent portion

83 Second bent portion

S1 Gap

What is claimed is:

1. An electrical connection unit comprising:
an electronic component including a terminal;
a wiring member;
a first metal member including a first portion fixed to the terminal by a first fastening member and a second portion fixed to the wiring member; and
a second metal member including a recess into which the second portion of the first metal member is fitted, the second metal member being attached to the second portion of the first metal member.

2. The electrical connection unit according to claim 1, wherein
the second metal member is a metal plate including a base portion, a first bent portion bent from a first end of the base portion, and a second bent portion bent from a second end of the base portion that is opposite to the first end to form the recess between the second bent portion and the first bent portion.

3. The electrical connection unit according to claim 1, wherein
the second portion is fixed to the wiring member by welding or rivet fixing, and
the second metal member is disposed to overlap the second portion from a side opposite to the wiring member.

4. The electrical connection unit according to claim 1, wherein
the second portion is fixed to the wiring member by a second fastening member,
the second fastening member protrudes from the second portion, and
the second metal member includes an insertion portion through which the second fastening member passes, and is disposed to overlap the second portion from a side opposite to the wiring member.

5. The electrical connection unit according to claim 1, wherein
the second portion is fixed to the wiring member by a second fastening member,
the second fastening member protrudes from the second portion, and
the second metal member includes a base portion positioned on a side opposite to the wiring member with respect to the second portion, and is attached to the second portion with a gap for accommodating a part of the second fastening member between the second portion and the base portion.
